(19) United States
(12) Patent Application Publication
(10) Pub. No.: US 2026/0111209 A1
(43) Pub. Date: Apr. 23, 2026

(54) LLM MODIFICATION OF INFRASTRUCTURE DESIGN

(71) Applicant: ORACLE INTERNATIONAL CORPORATION, Redwood Shores, CA (US)

(72) Inventors: Paul Gregory GREENSTEIN, Hopkinton, MA (US); Zbigniew HOLKA, Solihull (GB)

(21) Appl. No.: 18/919,887

(22) Filed: Oct. 18, 2024

(51) Int. Cl. G06F 8/65; G06F 8/10; G06F 8/34; G06F 40/40

(52) U.S. Cl. CPC G06F 8/65; G06F 8/10; G06F 8/34; G06F 40/40

(57) ABSTRACT

Systems, methods, and other embodiments associated with modification of existing infrastructure designs by large language models (LLMs) are described. In one embodiment, a method includes accessing an existing graph of compute infrastructure. The existing graph represents a design of the compute infrastructure. The method includes accessing changed infrastructure requirements for the compute infrastructure that differ from the design. The changed infrastructure requirements are in human language. The method includes automatically generating a modified graph from the existing graph and the changed infrastructure requirements using an LLM. The LLM has been trained to generate new graph portions where the compute infrastructure is affected by the changed infrastructure requirements. The method includes converting the modified graph into a deployment specification. And, the method includes executing the deployment specification to automatically configure a target computer system to have modified compute infrastructure that conforms to the changed infrastructure requirements.

### BACKGROUND

Cloud platforms have become popular tools for hosting software applications due to their adaptability, scalability, and accessibility. While the computing environment of a cloud platform is largely virtualized, clients of the cloud platform are tasked with the planning and configuration of physical infrastructure that executes the client's software applications. The processes for design modification and subsequent deployment of physical infrastructure are inconsistent and resistant to automation.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an infrastructure modification system that is associated with modification of existing infrastructure designs by an LLM.

FIG. 2 illustrates one embodiment of an infrastructure modification method that is associated with modification of existing infrastructure designs by an LLM.

FIG. 3 illustrates an example infrastructure modification process that is associated with modification of existing infrastructure designs by an LLM.

FIG. 4 illustrates an embodiment of a computing system configured with the example systems and/or methods disclosed.

### DETAILED DESCRIPTION

Systems, methods, and other embodiments are described herein that provide for modification of existing infrastructure designs by a large language model (LLM). In one embodiment, an infrastructure modification system employs an LLM to automatically revise an infrastructure design that already exists. The LLM adjusts the existing infrastructure design to conform to changes in infrastructure requirements, while satisfying other constraints on the changes to the existing infrastructure design. For example, the infrastructure design system automatically modifies aspects of the existing infrastructure that are affected by an update to infrastructure requirements, while leaving the remainder of the existing infrastructure design unchanged.

In one embodiment, the infrastructure modification system improves on LLM-based generation of infrastructure designs by providing autonomous adjustment of existing infrastructure designs to satisfy changed infrastructure requirements. This is an improvement over LLM-based generation in which the changed infrastructure requirements results in a completely original infrastructure design, which may not overlap at all with the existing infrastructure design. Advantageously, the infrastructure modification system enables LLM-based optimization of human-created infrastructure designs. Because the infrastructure modification system limits its adjustments to portions of the existing infrastructure design that are affected by the change in infrastructure requirements, unaffected portions of the existing infrastructure design which are stable, already debugged, and familiar to administrators are retained in the autonomous update to the existing infrastructure design. In another improvement, the infrastructure modification system does not need infrastructure requirements for an existing graph in order to modify the existing graph to conform to changed infrastructure requirements.

In one embodiment, the infrastructure modification system uses an LLM to automatically retain portions of the existing graph that are unaffected by the changed infrastructure requirements, and to automatically replace with newly generated graph those portions of the existing graph that are affected by the changed infrastructure requirements. The infrastructure modification system then converts the modified graph to an executable deployment specification. The infrastructure modification system executes the deployment specification to configure physical compute infrastructure to conform to the changed infrastructure requirements.

### Definitions

Infrastructure designs may be referred to herein more formally as infrastructure topologies. As used herein, “infrastructure topology” refers to a description of component configuration in a computing system as a graph (or collection of textual tokens translatable to a graph).

As used herein, “Logical Infrastructure Topology” (LIT) refers to a graph (or collection of textual tokens translatable to a graph) that represents an architecture of a system, focusing on the relationships and interactions between different functional elements or components without specifying the actual physical devices or resources involved. In a LIT, the emphasis is on how various components of the system are functionally organized and interconnected, such as the flow of data, communication paths, and the arrangement of software or service components. A LIT serves as a blueprint that outlines logical structure and behavior of the system, independent of the underlying physical infrastructure that will implement it.

As used herein, “Physical Infrastructure Topology” (PIT) refers to a graph (or collection of textual tokens translatable to a graph) that represents the concrete, real-world implementation of a system's architecture, specifying the actual physical devices, resources, and connections that support the logical components described in the LIT. In a PIT the emphasis is on detailing the specific hardware, network configurations, storage solutions, and other physical elements that will be used to realize the system. For example, this may include specifying devices like servers, routers, switches, IP address ranges, and the physical connections between them.

Note, a PIT serves as a mapping of the LIT onto actual infrastructure that will be deployed and managed in a data center or cloud environment. The process of creating the PIT accounts for the characteristics of the infrastructure other than function, such as operational characteristics. Thus, while LIT creation may disregard specifications about performance, response time, availability, etc. in the infrastructure requirements, creation of a PIT from the LIT takes note of these operational characteristics in the infrastructure requirements and generates a PIT that satisfies them along with the functional characteristics of the LIT.

Both LITs and PITs may be referred to generally herein as “graphs.”

As used herein, “infrastructure requirements” include (i) functional requirements that specify the tasks to be performed by a compute infrastructure and (ii) non-functional (i.e., operational) requirements that specify criteria for the operation of the compute infrastructure. The infrastructure requirements may be expressed in human language in a requirements document. For example, the infrastructure requirements may describe compute infrastructure with human language to a level of detail sufficient to enable design of the compute infrastructure. Note that the term “requirements” as used herein refers to items that are specified to be satisfied by the compute infrastructure, and should not be construed to indicate that any aspect or feature described herein is required.

As used herein, “Human language” refers to natural, everyday language used by people to communicate, including written text or spoken dictation that is used to express infrastructure requirements for compute infrastructure. Human language includes, but is not limited to, written and typewritten forms of text that are converted into electronic data, spoken dictation that is received by a computing device and converted into electronic data, and text extracted from spoken dictation using voice-to-text conversion and/or speech recognition technology. An item of electronic data (such as a changed infrastructure requirement) is “in human language” where the electronic data expresses, records, defines, stores, or otherwise represents textual (written) or vocal (spoken) human language.

As used herein, the terms “computing infrastructure” and “compute infrastructure” (occasionally referred to herein simply as “infrastructure” for short) refers to a collection of hardware, software, networks, facilities, and related services that deliver information technology operations.

No action or function described or claimed herein is performed by the human mind. An interpretation that any action or function can be performed in the human mind is inconsistent with and contrary to this disclosure.

### —Example Infrastructure Modification System—

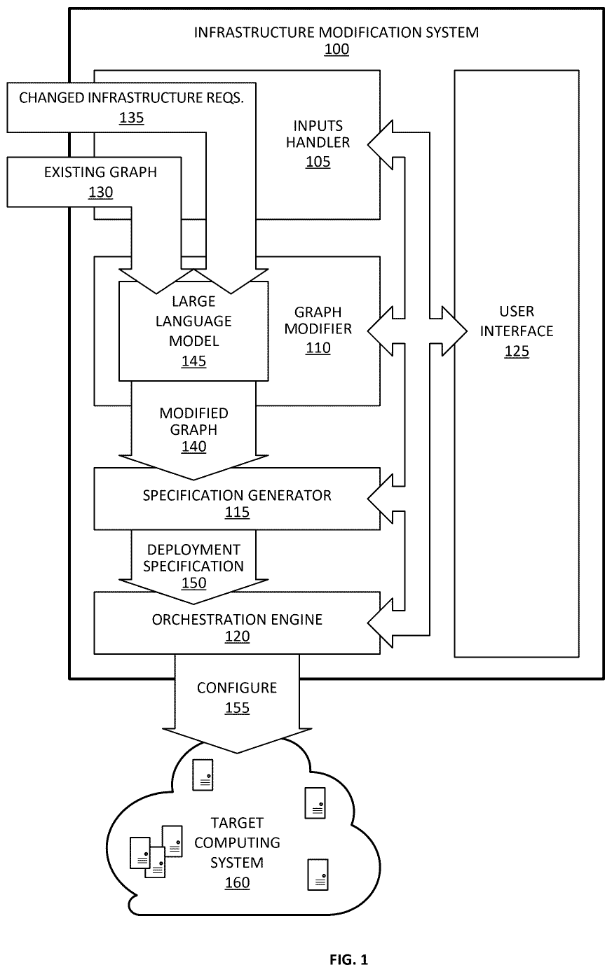

FIG. 1 illustrates one embodiment of an infrastructure modification system 100 that is associated with modification of existing infrastructure designs by an LLM. Infrastructure modification system 100 includes components configured to implement an LLM-based process for automatically modifying an existing logical or physical infrastructure topology in response to a change in associated infrastructure requirements. In one embodiment, infrastructure modification system 100 includes an inputs handler 105, a graph modifier 110, a specification generator 115, and an orchestration engine 120. In one embodiment, infrastructure modification system 100 may further include a user interface 125. In one embodiment, the components of infrastructure modification system 100 intercommunicate, for example by electronic messages as discussed below under the heading “Cloud or Enterprise Embodiments”.

In one embodiment, inputs handler 105 is configured to access (1) an existing graph 130 of compute infrastructure and (2) changed infrastructure requirements 135 for the compute infrastructure. The existing graph 130 (g₀) represents a design of the compute infrastructure. The compute infrastructure described by the changed infrastructure requirements 135 differs from the design for the compute infrastructure that is represented in the existing graph 130, with the exception of the case where the existing infrastructure design already supports the changed infrastructure requirements. Thus, changed infrastructure requirements 135 (Req) are “changed” with reference to original infrastructure requirements (Rego) that result in existing graph 130. Note, the original infrastructure requirements need not be known in order to modify the existing graph 130. The changed infrastructure requirements 135 are in human language. For example, the changed infrastructure requirements 135 may be textual descriptions or outlines of features of a compute infrastructure.

The changed infrastructure requirements 135 may detail what the compute infrastructure is to be re-configured to accomplish. For example, the changed infrastructure requirements 135 may include functional requirements: infrastructure requirements that describe what functions, behaviors, actions, or tasks the compute infrastructure is to perform. Functional requirements are considered when generating a LIT. And, for example, the changed infrastructure requirements 135 may include non-functional requirements, which may include performance criteria (such as response time, sustained volume of transactions, pace, etc.), operational constraints (e.g., availability, reliability, disaster recovery), technological constraints (e.g., standards compliance, desired technologies or products), and quality attributes (e.g., maximum tolerable defect rate and maintainability). Non-functional requirements may be disregarded when generating a LIT generation stage, and are considered when generating a PIT.

In one embodiment, graph modifier 110 is configured to automatically generate a modified graph 140 from the existing graph 130 and the changed infrastructure requirements 135 using an LLM 145. The LLM has been trained to generate, as modified graph 140, an entire new graph that satisfies the changed infrastructure requirements 135, subject to a constraint of minimizing changes with respect to the existing graph 130. In effect, the LLM has been trained to re-generate (or duplicate), in the modified graph 140, portions of the existing graph 130 where the compute infrastructure is unaffected by the changed infrastructure requirements 135 due to the constraint to minimize changes. And, in effect, the LLM 145 has been trained to generate, in the modified graph 140, new graph portions where the compute infrastructure is affected by the changed infrastructure requirements 135 to the graph being generated so as to satisfy the changed infrastructure requirements 135. A portion of the existing graph 130 is considered to be affected by the changed infrastructure requirements 135 where the portion of the existing graph 130 is not described by or indicated by the changed infrastructure requirements 135, and thus, does not correspond to, conform to, or otherwise represent any portion of the changed infrastructure requirements.

Because the changed infrastructure requirements 135 may pertain to the entire infrastructure, and not just to part of the infrastructure, the parts of the existing infrastructure graph 130 that are affected by the infrastructure graph remain unclear until after generation of modified graph 140. As an illustrative example, application 1 may require 2 CPUs, and application 2 may require 3 CPUs. In an existing graph 130 (g₀), the LLM 145 may assign applications 1 and 2 to be run on two VMs, with 2 and 3 CPUs, respectively. In a modified graph 140 (g₁), the LLM 145 may place applications 1 and 2 on a single 5 CPU VM, because one of the new requirements present in the changed infrastructure requirements 135 is to minimize the number of used IP addresses on subnet S. When LLM 145 examines the existing infrastructure topology 130, it discovers that subnet S is the subnet that houses VMs for applications. But, this is not known from reading the changed infrastructure requirements 135, so there is no way of making an advance conclusion that the 2 and 3 VMs are an affected part of the infrastructure.

Whether a portion of the graph is affected by the changed design requirements may be revealed by comparison of the modified graph 140 and existing graph 130. Accordingly, graph modifier 110 may be further configured to execute a graph comparison function. The graph comparison function identifies what has changed with re-generation of the infrastructure graph. In other words, the graph comparison function determines, after generation of the modified graph 140, which portions of the modified graph 140 have changed from existing graph 130 (if any). The graph comparison function can label portions of the graph as changed or unchanged. The results of the graph comparison may be provided as input to an evaluation for choosing from among multiple a modified graphs 140, such as a cost or time assessment, as discussed below.

In one embodiment, graph modifier 110 is configured to dynamically generate a prompt to LLM 145 to cause LLM 145 to produce the modified graph 140. The dynamically generated prompt is configured to initiate generation of the modified graph 140 by the LLM 145 from the changed infrastructure requirements 135 and the existing graph 130. In one embodiment, graph modifier 110 is configured to create the dynamically generated prompt by populating a template prompt with the changed infrastructure requirements 135 and the existing graph 130. Graph modifier 110 is configured to automatically submit the dynamically generated prompt to LLM 145. Graph modifier 110 is configured to capture the response of LLM 145 to the prompt and output the response as the modified graph 140.

In one embodiment, specification generator 115 is configured to convert the modified graph 140 into a deployment specification 150. The deployment specification 150 is configured to be executable by an orchestration engine, such as orchestration engine 120. In one embodiment, specification generator 115 is configured to produce the deployment specification 150 in a pre-selected configuration language. For example, the deployment specification 150 may be written in YAML code, such as in one or more Ansible playbooks, where orchestration engine 120 is configured to execute YAML code. Or, for example, the deployment specification 150 may be written in Terraform code, such as a configuration file(s) written in HashiCorp Configuration Language (HCL) code, where orchestration engine 120 is configured to execute HCL code.

In one embodiment, specification generator 115 is configured to generate code from a PIT graph. Accordingly, specification generator 115 is configured to check whether the modified graph 140 is a PIT graph or a LIT graph. Where specification generator 115 determines that modified graph 140 is a PIT graph, specification generator 115 is configured to proceed to generation of deployment specification 150 from the PIT graph. Where specification generator 115 determines that modified graph 140 is a LIT graph, specification generator 115 is configured to translate the modified graph 140 from a LIT graph to a PIT graph, based on the changed infrastructure requirements 135, and then proceed to generation of deployment specification 150 from the resulting PIT graph.

In one embodiment, orchestration engine 120 is configured to execute the deployment specification 150 to automatically configure 155 (that is, automatically apply a configuration to) a target computer system 160 to have modified compute infrastructure that conforms to the changed infrastructure requirements 135. In one embodiment, orchestration engine 120 is an instance of the automation engine Ansible—an automation framework and configuration management tool configured to provision compute infrastructure in accordance with tasks described in playbooks. In one embodiment, orchestration engine 120 is an instance of the core engine of Terraform—an infrastructure as code (IaC) tool configured to provision compute infrastructure as described in a declarative way in configuration files. Thus, in one embodiment, orchestration engine 120 is configured to orchestrate a deployment process to implement individual parts of the deployment specification in a correct order.

In one embodiment, target computing system 160 is physical compute infrastructure (i.e., a hardware environment) that is configurable into various PITs by orchestration engine 120. For example, target computing system 160 is a cloud computing system, such as (i) a public cloud operated by a third-party cloud service provider, (ii) a private cloud operated on premises of the enterprise client; or (iii) a hybrid cloud that incorporates resources both on premises of the enterprise client and in the environment of one or more cloud service providers, in any combination. In one embodiment, target computing system 160 is a virtualized on-premises data center. (Note, in one embodiment, the algorithms described herein for LIT and PIT modification are also applicable to non-virtualized environments. In a non-virtualized environment, the infrastructure modification method 200 below can proceed through block 220 to produce a build-out workflow or other deployment specification. The subsequent automated configuration described in block 225 relies on virtualization.)

Target computing system 160 includes computing hardware components that inter-operate to provide computing resources. For example, target computing system 160 includes one or more bare metal computer servers (which include physical processors, memory, and non-transitory computer-readable storage media) interconnected by a physical data network. Target computing system 160 is configured to host physical compute infrastructure, including virtual machines, networks and subnetworks, databases and other storage, load balancers, bastions, gateways, firewalls, or other infrastructure components. Such compute infrastructure components may be provisioned atop the underlying bare metal hardware of target computing system 160.

In one embodiment, user interface 125 is configured to present outputs of the infrastructure modification system 100 and accept inputs from a user of the infrastructure modification system 100. In one embodiment, the user interface 125 is a graphical user interface (GUI). In one embodiment, the user interface 125 may be a GUI that is duplex, that is, a user interface that supports two-way communication between the user and infrastructure modification system 100 in real time or near real time. For example, user interface 125 may be shown on a display of a computer terminal.

The GUI may be configured to display an infrastructure graph (such as existing graph 130 or modified graph 140) graphically. In one embodiment, presenting an infrastructure graph in user interface 125 includes parsing the graph representation language of the infrastructure graph to identify entities and relationships between the entities. And, once the entities and relationships are detected, presentation further displays the entities (such as servers, bastions, load balancers, compute instances, and databases) as nodes, interconnected by edges representing the relationships between the entities. For example, the graph of entities and relationships may be shown on the display of the computer terminal.

In one embodiment, the user interface 125 may be configured to show changes in modified graph 140 with respect to existing graph 130. For example, user interface 125 may be configured to graphically highlight portions of the modified graph 140 that differ from the existing graph. For example, the nodes and edges of the modified graph 140 that have not changed from those in existing graph 130 may be shown in a first color, such as black. And, the nodes and edges of the modified graph 140 that have changed from those in existing graph 130 may be shown in a second color, such as red. Also, nodes and edges that have been removed in the modified graph 140, and which were present in existing graph 130 may be shown in a third color, such as gray. In one embodiment, this coloration may also apply to text describing nodes and edges in the modified graph 140. In one embodiment, the user interface 125 may be configured to show modified graph 140 alongside existing graph 130, to allow for visual comparison. In one embodiment, graph modifier 110 is configured to execute a graph comparison function to compare existing graph 130 with modified graph 140 to detect changes, and to label changed nodes and edges in modified graph 140. The user interface 125 may be configured to parse and interpret the labels designating the changes, and highlight the nodes and edges labeled as changed.

In one embodiment, the user interface 125 is configured to present the modified graph 140 for user approval before proceeding to convert the modified graph 140 into the executable deployment specification. In one embodiment, user interface 125 is configured to solicit user inputs, such as approvals or corrections regarding the modified graph 140. In one embodiment, user interface 125 includes user interface elements configured to accept user inputs. For example, user interface 125 may include text boxes, selection controls (such as dropdown menus, radio buttons, checkboxes, and toggle switches). The user interface 125 may be configured to accept corrections, adjustments, or other changes to aspects of entities and relationships through user interface elements that are associated with the entities and relationships. In one embodiment, the user interface 125 is configured to enable the user to remove or add entities and relationships, and further to enable the user to rearrange the relationships between entities. The GUI may be configured to allow a user to interactively modify the infrastructure graph, for example by drag-and-drop of visual elements (such as nodes and edges of the infrastructure graph).

The user interface 125 may be configured to accept an identification or specification of a target system to be configured in accordance with the changed infrastructure requirements 135 through the user interface elements. The user interface 125 may also include buttons, such as a button to approve a modified graph 140 with no changes, a button to submit changes to the modified graph 140, or other action buttons. The user interface 125 may also include file upload controls that allow the user to specify a file that includes the changed infrastructure requirements 135 and a file that includes the existing graph 130.

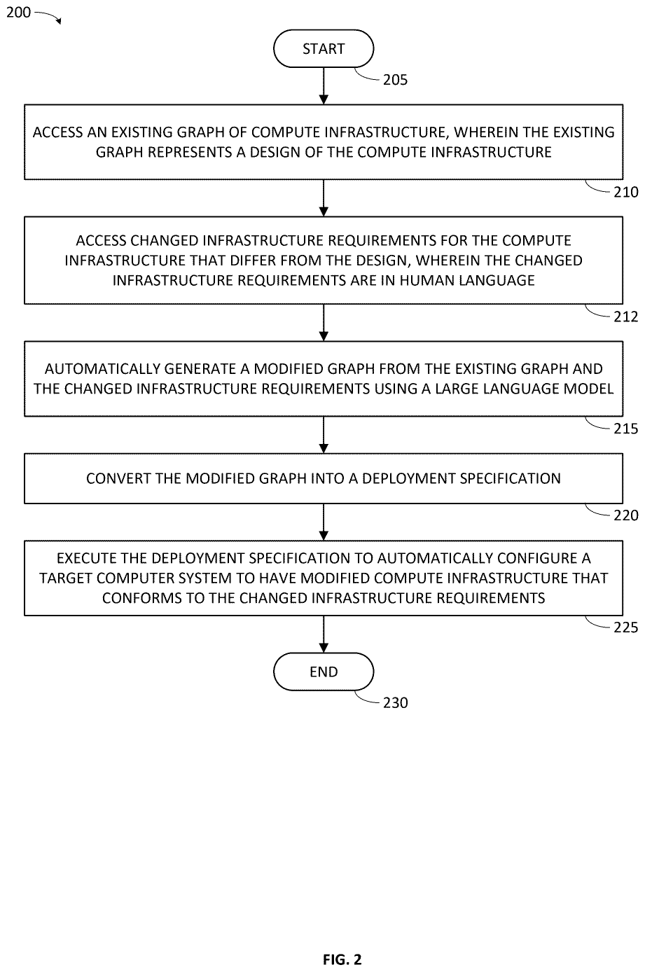

Further details regarding infrastructure modification system 100 are presented herein. In one embodiment, operations of infrastructure modification system 100 will be described with reference to infrastructure modification method 200 of FIG. 2.

### —Example Infrastructure Modification Method—

FIG. 2 illustrates one embodiment of an infrastructure modification method 200 that is associated with modification of existing infrastructure designs by an LLM. Infrastructure modification method 200 is one example method for automatically modifying an existing infrastructure design in response to changed infrastructure requirements with minimal disruption to portions of the design that are unaffected by the changed requirements.

In one embodiment, as a general overview, infrastructure modification method 200: (i) accesses an existing graph of compute infrastructure and changed infrastructure requirements for the compute infrastructure that differ from the compute infrastructure; (ii) automatically generates a modified graph from the existing graph and the changed infrastructure requirements using an LLM that generates new graph portions where the compute infrastructure is affected by the changed infrastructure requirements; (iii) converts the modified graph into a deployment specification; and (iv) executes the deployment specification to automatically configure a target computer system to have modified compute infrastructure that conforms to the changed infrastructure requirements.

In one embodiment infrastructure modification method 200 initiates at START block 205 in response to infrastructure modification system 100 determining one or more of (1) that infrastructure modification system 100 has received an instruction to modify an infrastructure topology as to conform with changes to infrastructure requirements for the infrastructure topology; (2) infrastructure modification system 100 has received a changed or updated set of human-language infrastructure requirements for computing infrastructure; (3) that an instruction to perform infrastructure modification method 200 has been received; (4) a user or administrator has initiated infrastructure modification method 200; (5) it is currently a time at which infrastructure modification method 200 is scheduled to be run; or (6) infrastructure modification method 200 should commence in response to satisfaction of some other condition. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of infrastructure modification system 100 executes infrastructure modification method 200. In one embodiment, at START block 205, infrastructure modification system 100 (1) provisions (i.e., allocates and initializes) resources of the computing system that are used by infrastructure modification system 100, such as processor, memory and storage (for example, for holding outputs of the generated infrastructure topologies and executable deployment specifications), (2) establishes access to one or more networks for the resources, such as access to (a) internal networks for communication among components of the infrastructure modification system 100 and (b) external networks for communication with other computing systems (for example, the target computing system); (3) connects to data sources (such as databases, data stores, file systems, and cloud storage) used by the infrastructure modification method 200, such as data sources that hold the changed infrastructure requirements, existing graph, and trained LLM(s); and (4) configures the computing system with system settings, software dependencies and libraries, and modules for the components of infrastructure modification system 100. Following initiation at START block 205, infrastructure modification method 200 proceeds to block 210.

At block 210, infrastructure modification method 200 accesses an existing graph 130 of compute infrastructure. The existing graph 130 represents a design of the compute infrastructure. For example, infrastructure modification method 200 obtains an existing graph 130 that represents a prior or current design iteration for the compute infrastructure that has not yet been adapted to the changed design requirements 135. The infrastructure modification method 200 gets the existing graph 130 from its location in storage or memory. The existing graph 130 may be provided in a file located at a provided file path, as a specified record in a database, or received by input through a user interface 125. In one embodiment, retrieves the existing graph 130 from its location in storage, and makes it available for use by downstream processes.

In one embodiment, the existing graph 130 (and the modified graph 140 discussed below) are infrastructure graphs. The infrastructure graphs include nodes and edges. The nodes represent infrastructure entities. As a non-exhaustive list of examples, the nodes may represent virtual machines (such as compute units or bastions), Kubernetes nodes, load balancers, and storage devices (such as boot volumes, storage volumes, and databases). The edges represent connections between the infrastructure entities, such as a network path or a storage device connection. The infrastructure graphs may be LIT graphs or PIT graphs.

In one embodiment, infrastructure modification method 200 accesses an existing graph 130 of compute infrastructure and changed infrastructure requirements 135 for the compute infrastructure by locating and retrieving the existing graph 130. To locate and retrieve existing graph 130, infrastructure modification method 200 (i) obtains the storage location for the existing graph 130, for example by receiving the storage location as an input to a user interface 125; (ii) accesses the storage location (e.g., file system, database, or cloud storage) where the existing graph 130 of the compute infrastructure is saved; and (iii) loads the graph data of the existing graph 130 into memory for subsequent processing.

In one embodiment, the steps of block 210 are performed by inputs handler 105. At the conclusion of block 210, infrastructure modification method 200 has made available the existing graph 130 for downstream processing. Processing continues to block 212.

At block 212, infrastructure modification method 200 accesses changed infrastructure requirements 135 for the compute infrastructure that differ from the design. The changed infrastructure requirements 135 are in human language. For example, infrastructure modification method 200 obtains the changed infrastructure requirements 135 that describe an alteration(s) of the compute infrastructure. The alteration(s) contained in the changed infrastructure requirements 135 introduces changes to the existing setup of the compute infrastructure. The infrastructure modification method 200 gets the changed infrastructure requirements 135 from their location in storage or memory. In one embodiment, infrastructure modification method 200 is provided with a pre-specified duplet (pair) of existing graph 130 and changed infrastructure requirements 135. The changed infrastructure requirements 135 may be provided in a file located at a provided file path, as a specified record in a database, or received by input through a user interface 125. In one embodiment, infrastructure modification method 200 retrieves the changed infrastructure requirements 135 from their location in storage, and formats them for use by downstream processes.

As discussed above with reference to inputs handler 105, the changed infrastructure requirements 135 are in human language. Because the changed infrastructure requirements 135 are in human language, the changed infrastructure requirements 135 may therefore be informal, and not necessarily follow a particular structure. In one embodiment, the changed infrastructure requirements 135 are stored as electronic data in a data structure capable of storing human language text, such as a text file, Word document file, PDF file, and so on. In one embodiment, the changed infrastructure requirements 135 are stored as electronic data in a data structure capable of storing human language dictation, such as an audio or audio-video file in one of many formats such as MP3 (MPEG-1 Audio Layer III), WAV (Waveform Audio File Format), AAC (Advanced Audio Coding), AIFF (Audio Interchange File Format), OGG (Ogg Vorbis), MP4 (MPEG-4 Part 14), AVI (Audio Video Interleave), MKV (Matroska Video File), other MPEG formats, and so on.

In one embodiment, infrastructure modification method 200 accesses changed infrastructure requirements 135 for the compute infrastructure by locating and retrieving the changed infrastructure requirements 135. To locate and retrieve the changed infrastructure requirements 135, infrastructure modification method 200 (i) obtains the storage location for the changed infrastructure requirements 135, for example by receiving the storage location as an input to a user interface 125; (ii) accesses the storage location (e.g., file system, database, or cloud storage) where the changed infrastructure requirements 135 are stored; and (iii) reads the human-language text of the changed infrastructure requirements 135 into memory for subsequent processing.

In one embodiment, the steps of block 212 are performed by inputs handler 105. At the conclusion of block 212, infrastructure modification method 200 has made available the changed infrastructure requirements 135 for downstream processing. Processing continues to block 215.

At block 215, infrastructure modification method 200 automatically generates a modified graph 140 from the existing graph 130 and the changed infrastructure requirements 135 using a LLM 145. For example, the infrastructure modification method 200 feeds the existing graph 130 and the changed infrastructure requirements 135 into the LLM 145 to cause the LLM 145 to integrate alterations from the changed infrastructure requirements 135 into the existing graph 130, producing the modified graph 140. LLM 145 preserves unaffected parts of the existing graph 130 while updating areas affected by the changed infrastructure requirements. In other words, the LLM 145 applies the changed infrastructure requirements 135 to the existing graph 130 while reusing or keeping sections of the existing graph 130 that are unaffected by revised items in the changed infrastructure requirements 135.

Note that there are four possible cases here: (1) the modified graph includes (is a proper superset of) the original graph, (2) the original graph and the modified graph are identical (described below), (3) the original graph includes (is a proper superset of) the modified graph, and (4) neither the original nor the modified graphs include one another (with empty or non-empty intersection). In the first case, the infrastructure grew as a result of the change. In the second case, the infrastructure remained unchanged (i.e., the new requirement was already satisfied by the original infrastructure). In the third case, the requirement resulted in a reduction of the infrastructure (e.g., as a result of resource optimization by LLM). In the last case, some elements were removed but others were added.

In one embodiment, the LLM 145 has been trained to re-generate portions of the existing graph 130 where the compute infrastructure is unaffected by the changed infrastructure requirements 135, and to generate new graph portions where the compute infrastructure is affected by the changed infrastructure requirements 135. Additional detail on training of LLM 145 is provided elsewhere herein, for example under the heading “Example LLM Training”. The LLM 145 operates to replicate stable parts of the existing graph 130 in the modified graph 140 while producing new graph elements for areas influenced by the changed infrastructure requirements. In this way, the LLM 145 automatically produces a modified graph 140 that aligns with the changed infrastructure requirements 135 while preserving intact those portions of the existing graph 130 that are unaffected by the changed infrastructure requirements.

Note, it is possible in some situations that changed infrastructure requirements 135 do not affect any portions of the existing graph 130. This more likely in situations where, for example, (1) the changes in the changed infrastructure requirements 135 with respect to prior infrastructure requirements that resulted in the existing graph are minor; or (2) the changes in the changed infrastructure requirements 135 only affect items that occur in PIT graphs and the existing graph 130 is a LIT graph. Accordingly, in such situations, the LLM 145 will replicate the existing graph 130 when generating the modified graph 140.

In one embodiment, the LLM 145 has been trained to adjust the existing graph 130 to conform to the changed infrastructure requirements 135 while satisfying one or more criteria. For example, the LLM may be trained to generate a modified graph that satisfies a criterion of making “as few changes to the existing graph 130 as possible.” The criterion may vary. Example criteria include, but are not limited to minimum topology difference, minimum node difference (allowing any edge difference), minimum edge difference (allowing any node difference), minimum cost (or TCO (total cost of ownership), if pertinent to computing infrastructure) per cost attribution based on node and edge types, etc. Various criteria may be presented in user interface 125 for selection when initiating a modification of an existing graph 130. In one embodiment, alternative LLMs are used for the various criteria. Here, a specialized LLM that has been specifically trained to satisfy the selected criteria when generating modified graph 140 is accessed and used in response to the user selection of the criteria. In another embodiment, a LLM that has been more generally trained to satisfy an indicated one of several criteria is used to generate the modified graph 140. Here, the prompt to the LLM 145 (discussed below) is modified to specify the criteria to the LLM.

Further, the criteria for modification of LIT graphs may differ from the criteria for modification of the PIT graphs. For example, a modification of an existing LIT graph may be subject to a criterion of minimal change of topology, while a modification of a PIT graph that corresponds to the LIT graph may be subject to a criterion of minimum TCO.

Also, in some situations (such as when the existing graph 130 is a PIT graph) the preference may be given to a non-minimal difference between the existing graph 130 and the modified graph 140, for which the resulting modified graph 140 would satisfy some important criteria or constraints, such as choices of technologies or products, ability to use standard services, ability to map to the available skills of operational personnel, and so on. Such situations may occur during infrastructure upgrades or refreshes.

In one embodiment, the infrastructure graphs (such as existing graph 130 and modified graph 140) may be expressed or encoded as sequences of tokens in a text-based graph representation language (GRL), rendering the infrastructure graphs amenable to processing and generation by a LLM 145. Various GRLs may be appropriate for encoding an infrastructure graph, including but not limited to: JSON-Graph, graph modeling language (GML), GraphML, Graphviz DOT, trivial graph format (TGF), and resource description framework (RDF). In one embodiment, the LLM 145 is trained specifically to generate graphs in one GRL. In this case, when generating graphs in another GRL, an alternative version of the LLM 145 is used which has been trained to generate graphs in the other GRL. In another embodiment, the LLM 145 is trained to generate graphs in more than one GRL. In this case, the LLM 145 generates output in a GRL that was specified in a prompt to the LLM 145.

In one embodiment, infrastructure modification method 200 provides the existing graph 130 and changed infrastructure requirements 135 to LLM 145 in a prompt. The prompt is configured to cause LLM 145 to generate modified graph 140. In one embodiment, infrastructure modification method 200 dynamically generates a prompt for generation of the modified graph 140 from the changed infrastructure requirements 135 and the existing graph 130, submits the prompt to the LLM 145, and then captures the modified graph 140 provided as a response from the LLM 145 to the prompt. In one embodiment, capturing the modified graph involves parsing the response of the LLM to extract the modified graph from other content of the response, and storing the extracted content for subsequent processing. In one embodiment, the LLM is configured to return a response with only GRL code for the modified graph, in which case the extraction is simple copying. In one embodiment, the LLM may return a response that includes other, superfluous content in addition to the GRL code for the modified graph, such as human language statements like “The modified infrastructure graph is:” followed by the code. In this case, the extraction parses the graph to copy the GRL code, and excludes extraneous human language statements. For example, the infrastructure modification method 200 may parse the response to retain content written in GRL code, and discard other content of the response.

In one embodiment, the prompt for generation of the modified graph 140 is dynamically generated by loading and populating a template prompt for graph modification. The template prompt is a pre-defined text structure that includes placeholders or populatable fields that accept specific data at runtime. The template prompt serves as a blueprint for creating consistent, standardized inputs that are tailored to the task of graph modification. The template prompt for graph modification includes, as populatable fields: (i) changed infrastructure requirements (expressed as human language text), (ii) the existing graph (expressed in GRL), and (iii) a specification of the GRL to be used for the output modified graph. The template prompt for graph modification includes instructions to generate a modified graph 140 in the GRL from the changed infrastructure requirements 135 and the existing graph 130. For example, the template prompt for graph modification may be something like:

“Given the existing infrastructure topology graph: [Existing_Graph]
And the new infrastructure requirements:
[Changed_Design_Requirements]
Generate a modified infrastructure graph in
[Graph_Representation_Language] that conforms to the
infrastructure requirements by making as few changes as possible
with to the existing infrastructure topology graph.”

Infrastructure modification method 200 submits the populated prompt for generation of the modified graph 140 to the LLM 145. For example, infrastructure modification method 200 makes a call to an application programming interface (API) endpoint of the LLM 145: the prompt is placed in the payload of a request, along with any additional parameters such as model selection, temperature (randomness), maximum number of tokens, etc.; and the request is passed (e.g., by HTTP POST) to the API endpoint of the LLM 145.

The LLM 145 tokenizes and embeds the prompt for generation of the modified graph 140, including the changed infrastructure requirements 135, existing graph 130, and selected GRL. LLM 145 applies attention mechanisms to focus on relevant parts of the changed infrastructure requirements 135 and existing graph 130 that form the design of the modified graph 140. For example, the LLM 145 is trained to focus on understanding how the functional components and their interactions and physical features as laid out in the changed infrastructure requirements 135 differ from the nodes and edges of the existing graph 130. The LLM 145 applies its trained understanding of logical and physical infrastructure design principles to synthesize the relevant parts of the changed infrastructure requirements 135 into modifications to the existing graph 130, thereby generating a modified graph 140. For example, the LLM 145 generates a series of graph representation language tokens that make up the modified graph 140.

In one embodiment, the attention mechanisms of LLM 145 include one or more attention heads that determine the importance of tokens among a sequence of tokens. The attention heads focus on specific context within the sequence that influences the decision to add, remove, or update portions of the existing graph 130. In general, the attention heads determine importance of a token based on context—the various relationships of a token to concepts or other tokens in the sequence. Here, the attention heads of the LLM 145 serve to map input to particular changes to the existing graph 130 by giving greater importance to specific tokens that correspond to (i) components that are present in the changed infrastructure requirements 135 and are not present in the existing graph 130, (ii) components that are not present in the changed infrastructure requirements 135 and which are present in the existing graph 130, and (iii) components that are present in both the changed infrastructure requirements 135 and the existing graph 130 while having differing configurations.

Infrastructure modification method 200 captures and stores the GRL expression of the modified graph 140 produced by the LLM 145 in response to the prompt. The modified graph 140 is thus expressed as a text data structure. For example, infrastructure modification method 200 reads the text of the modified graph 140 from an API endpoint of the LLM 145 and writes the text of the modified graph 140 to a file, database, memory, or other storage to make the modified graph 140 available for subsequent use.

In one embodiment, as discussed in further detail below with reference to infrastructure modification process 300, infrastructure modification method 200 automatically generates a modified graph 140 (g₁) from an existing graph 130 (g₀) by (i) checking whether an existing PIT PIT₀ fails to satisfy the changed requirements Req₁ at the PIT level without modification (see existing PIT check 302); (ii) checking whether an existing LIT LIT₀ that corresponds to the existing PIT PIT₀ nevertheless satisfies the changed requirements Req₁ at the LIT level without modification (see existing LIT check 304); and (iii)(a) where the existing LIT LIT₀ satisfies the changed requirements Req₁ at the LIT level, generating a modified PIT PIT₁ from the existing LIT LIT₀ (see PIT₁ from LIT₀ generation 306), thereby generating a modified graph (PIT₁) from an existing graph (PIT₀) by way of an intermediate LIT graph; or (iii)(b) where the existing LIT LIT₀ does not satisfy the changed requirements Req₁ at the LIT level, initially generating a modified LIT LIT₁ from the existing LIT LIT₀ (see LIT₁ from LIT₀ generation 308), thereby generating modified graph (LIT₁) from an existing graph (LIT₀), and then generating the modified PIT PIT₁ from the modified LIT LIT₁ (see PIT₁ from LIT₁ generation 310), thereby generating the thereby generating a modified graph (PIT₁) from an existing graph (PIT₀) by way of an intermediate LIT graph.

In one embodiment, more generally, infrastructure modification method 200 automatically generates a modified graph 140 from the existing graph 130 and the changed infrastructure requirements 135 using a LLM 145 by (i) dynamically generating a prompt containing the existing graph 130 expressed in a GRL, the changed infrastructure requirements 135 expressed as human readable text, and a specification of the GRL to be used for the output; (ii) making an API call to LLM 145 that delivers the prompt as a payload; (iii) tokenizing and embedding the prompt; (iv) applying attention mechanisms of the LLM 145 to focus on parts of the changed infrastructure requirements 135 and existing graph that indicate modification; (v) generating the modified graph 140 using LLM 145; (vi) capturing the resulting modified graph 140 returned by the LLM 145; and (vii) storing the modified graph 140 for subsequent use.

In one embodiment, the steps of block 215 are performed by graph modifier 110. At the conclusion of block 215, infrastructure modification method 200 has generated a modified graph 140 by execution of an LLM 145 on the existing graph 130 and changed infrastructure requirements 135. Processing continues to block 220.

At block 220, infrastructure modification method 200 converts the modified graph 140 into a deployment specification 150. Where the modified graph 140 is a LIT graph, the infrastructure modification method 200 converts the modified graph 140 from a LIT graph to a PIT graph (as discussed in further detail below with reference to infrastructure modification process 300 as a preliminary, intermediate step of the conversion to the deployment specification 150. Where the modified graph 140 is a PIT graph, the infrastructure modification method 200 converts the modified graph 140 directly into a deployment specification 150 because intermediate conversion from LIT graph to PIT graph is unnecessary.

In one embodiment, infrastructure modification method 200 may execute a script or other tool that is configured to map the components of a PIT graph to a syntax of the deployment specification 150 (such as YAML or HCL). Infrastructure modification method 200 thus automates adaptation of the PIT graph to an executable configuration or executable setup tasks. Infrastructure modification method 200 thus transposes modified graph 140 into a set of instructions that can be autonomously carried out by a computer to set up and deploy the compute infrastructure described in the changed infrastructure requirements 135.

In one embodiment, the tool for conversion of the PIT graph to the deployment specification 150 may be referred to as an IaC (infrastructure-as-code) specification generator. At a high level, operation of the IaC specification generator varies based on the destination tool. For example, to convert a PIT graph to a YAML Ansible playbook, the IaC specification generator maps the components of the PIT graph to the YAML syntax for tasks and roles that are executable by Ansible. Or, for example, to convert the PIT graph to an HCL Terraform configuration file, the IaC specification generator maps the components of the PIT graph to the HCL syntax for declarative provisioning that is executable by Terraform.

In one embodiment, infrastructure modification method 200 operates an IaC specification generator to convert the PIT graph into an executable deployment specification. The infrastructure modification method 200 receives and parses the input PIT graph to identify the components of the topology. The parsing recognizes the components based on predefined attributes associated with components. Attributes of components are specific characteristics or properties associated with individual components in the topology that provide details about the component such as type, size, location, or function of the component within the compute infrastructure. Examples of attributes include type of a component (e.g., bastion, load balancer, compute instance, database, subnet, gateway, etc.), unique identifier or other resource name given to a component, and configuration details that are related to a component.

When parsing the PIT graph, infrastructure modification method 200 examines the graph elements for attributes that identify what a component is and how it is connected. Infrastructure modification method 200 recognizes components by matching attributes using a predefined schema or set of rules to match attributes to pre-defined component types. For example, a component with attributes such as “type: virtual_machine” and “cpu_count: 4” would be recognized as a virtual machine (compute instance) that is to be added to the deployment specification. And, for example, a component with attributes such as “type: network” and an “ip_range” would be recognized as a network or sub-network that is to be configured by the deployment specification. Such recognition may be performed by evaluating regular expressions, or other Boolean matching. In this way, based on recognition of attributes, infrastructure modification method 200 can classify the components that correspond to specific resource types in the deployment specification.

Once the components of the PIT graph are classified by type, infrastructure modification method 200 assembles the deployment specification. The deployment specification is written in infrastructure code (e.g., HCL or YAML code), which is used to define and automate deployment of infrastructure. In one embodiment, infrastructure modification method 200 generates configuration blocks of infrastructure code for each component. In one embodiment, the infrastructure code declaratively defines the compute infrastructure that is to be created by execution of the infrastructure code, as is the case with HCL. In one embodiment, the infrastructure code specifies the steps to be performed by execution of the code which will result in creation of the compute infrastructure, such as is the case with YAML.

Infrastructure modification method 200 then assembles the configuration blocks into a deployment specification file (e.g., Terraform configuration file or Ansible playbook). The blocks are placed into the deployment specification file in a coherent order, that, when executed, will result in a compute infrastructure that conforms to the PIT graph. In one embodiment, related components are placed into the deployment specification file in positions that ensure dependencies are properly handled (e.g., ensuring subnetworks are defined before compute instances that used the subnetworks).

In one embodiment, to generate the configuration blocks, infrastructure modification method 200 accesses and retrieves configuration templates or patterns of infrastructure code that correspond to the type of the components. Infrastructure modification method 200 populates the configuration templates for the individual components of the PIT graph based on the specific attributes of the individual components to produce the configuration blocks for the individual components. For example, a number of CPUs, amount of memory, and disk size specified for an individual compute instance in the PIT graph would be used to populate the corresponding fields for the compute instance in the configuration block. The infrastructure modification method then inserts or adds the completed configuration blocks to the deployment specification. Once the components of the PIT graph are added to the deployment specification, the deployment specification is completed.

Infrastructure modification method 200 then stores completed deployment specification is then stored for subsequent execution. For example, the finalized deployment specification is written to a file. The file may be, for example, a *.yml file for an Ansible YAML playbook, or a *.tf file for a Terraform HCL configuration file.

In one embodiment, the steps of block 220 are performed by specification generator 115. At the conclusion of block 220, infrastructure modification method has converted the modified graph 140 to an executable deployment specification 150, which may be consumed by an orchestration engine 120 to automatically configure infrastructure according to the changed infrastructure requirements 135. Processing continues to block 225.

At block 225, infrastructure modification method 200 executes the deployment specification 150 to automatically configure 155 a target computer system 160 to have modified compute infrastructure that conforms to the changed infrastructure requirements 135. For example, infrastructure modification method 200 may execute the deployment specification 150 to automatically configure infrastructure of the target computing system 160 as described by the changed infrastructure requirements 135. In one embodiment, infrastructure modification method 200 takes the deployment specification 150 as input; parses the deployment specification 150 to determine the declarations or sequence of actions for provisioning and configuring in the target computing system 160 the infrastructure that is described in the deployment specification 150; executes the declarations or sequence of actions to provision and configure the infrastructure in the target computing system 160, and thereby outputs a fully configured target computer system 160 that matches the compute infrastructure outlined in the changed infrastructure requirements. Infrastructure modification method 200 thus uses the deployment specification 150 to automatically set up the target computer system 160 in a way that conforms to the changed infrastructure requirements.

Note that two different approaches to building the changed PIT are possible:
1. Build the entire modified infrastructure, in parallel with presumably existing and possibly functioning old infrastructure. Once done, instantly switch from the old to the new infrastructure. This provides for easier migration/upgrade/switch to the new infrastructure and supports quick fallback to the old infrastructure should something go wrong.
2. Modify the old infrastructure in place to match the new. The build process may be shorter and simpler, but it lacks the advantages of 1, and may make the old infrastructure unavailable for the duration.

In the context of 2, the projected elapsed time of the change may be relevant and may become a criterion for choosing the new infrastructure design from a set of valid alternatives.

In one embodiment, infrastructure modification method 200 initializes an orchestration engine 120 for executing the deployment specification 150. For example, infrastructure modification method 200 loads IaC tools and libraries used to interpret and execute the deployment specification 150. And, infrastructure modification method 200 configures access to the target computing system, for example providing credentials for the target computing system, establishing network access to the target computing system, and obtaining authorization permissions to interact with the target computing system.

In one embodiment, infrastructure modification method 200 loads the deployment specification 150. For example, infrastructure modification method 200 reads the deployment specification 150 (e.g., a YAML or HCL file) from its location in storage. Then, infrastructure modification method 200 parses the deployment specification 250 to identify the infrastructure components (e.g., virtual machines, networks, storage, and security groups) that are to be provisioned and configured in the target computing system 160. And, infrastructure modification method 200, generates a process or execution strategy that specifies steps that achieve the specified state of infrastructure in the target computing system 160.

In one embodiment, infrastructure modification method 200 then sets up the specified state of infrastructure in the target computing system 160. For example, infrastructure modification method 200 provisions the infrastructure components in the target computing system 160, for example allocating resources (e.g., providing the specified CPU, RAM, and storage of a given virtual machine) and applying network settings and access controls. Once the components are provisioned, infrastructure modification method 200 applies additional configuration tasks (if any) that are specified in the deployment specification, such as installing software, setting up services, and configuring application settings on the provisioned infrastructure.

Then, in one embodiment, infrastructure modification method 200 grants a client network access to the provisioned and configured compute infrastructure in the target computing system 160. In one embodiment, infrastructure modification method 200 returns one or more IP addresses, DNS names, and/or endpoint URLs for accessing the provisioned and configured compute infrastructure. In one embodiment, individual infrastructure components are directly addressable by IP address or DNS name. In one embodiment, discrete endpoint URLs are provided that are specific to particular services that are available in the provisioned and configured compute infrastructure, such as an endpoint for storage or for a database. In one embodiment, an API gateway provides a unified endpoint URL through which API requests are routed to services configured to handle the requests in the provisioned and configured compute infrastructure.

In one embodiment, the steps of block 225 are performed by orchestration engine 120. At the conclusion of block 225, infrastructure modification system has automatically configured compute infrastructure of a target computing system 160 as specified by the changed infrastructure requirements 135. Processing proceeds to END block 230, where infrastructure modification method 200 completes.

At the conclusion of infrastructure modification method 200, the design modification and deployment processes are made fully automatic. This is a substantial improvement over existing processes for modifying infrastructure. In a further improvement to LLM-based modification of infrastructure topologies, the LLM is constrained to create modified infrastructure graphs that satisfy additional criteria, such as limiting or minimizing unnecessary modifications away from an existing (baseline) infrastructure graph.

### —Further Features of Infrastructure Modification Method—

In one embodiment, automatic generation of the modified graph 140 from the existing graph 130 and the changed infrastructure requirements 135 using the LLM 145 (discussed at block 215) includes steps to convert the inputs of the changed infrastructure requirements 135 and existing graph 130 into a prompt to the LLM 145 dynamically, or on-the-fly. In one embodiment, the infrastructure modification method 200 dynamically generates a prompt to the LLM 145. The prompt is configured to initiate the generation of the modified graph 140 from the changed infrastructure requirements 135 and the existing graph 140 by the LLM 145. Then, the infrastructure modification method 200 automatically submits the prompt to the LLM 145.

In one embodiment, automatic generation of the modified graph 140 from the existing graph 130 and the changed infrastructure requirements 135 using the LLM 145 (discussed at block 215) includes steps to produce, as modified graph 140, a modified PIT when an existing PIT does not satisfy the changed infrastructure requirements 135 while the existing LIT corresponding to the existing PIT does satisfy the changed infrastructure requirements 135. As discussed in detail with reference to infrastructure modification process 300, in one embodiment the infrastructure modification method 200 determines that the existing graph 130 is an existing PIT that does not satisfy the changed infrastructure requirements 135. The infrastructure modification method 200 determines that an existing LIT that corresponds to the existing PIT does satisfy the changed infrastructure requirements 135. The infrastructure modification method 200 dynamically generates a prompt to the LLM 145. The prompt is configured to initiate generation of a modified PIT from the changed infrastructure requirements 135 and the existing LIT. The infrastructure modification method 200 automatically submits the prompt to the LLM 145. And, the infrastructure modification method 200 captures the modified PIT from a response of the LLM 145 to the prompt. Here, the modified graph 140 is the modified PIT.

In one embodiment, automatic generation of the modified graph 140 from the existing graph 130 and the changed infrastructure requirements 135 using the LLM 145 (discussed at block 215) includes steps to produce, as modified graph 140, a modified PIT when neither of an existing PIT nor the existing LIT that corresponds to the existing PIT satisfies the changed infrastructure requirements 135. As discussed in detail with reference to infrastructure modification process 300, in one embodiment the infrastructure modification method 200 determines that the existing graph 130 is an existing PIT that does not satisfy the changed infrastructure requirements 135. Infrastructure modification method 200 determines that an existing LIT that corresponds to the existing PIT does not satisfy the changed infrastructure requirements 135. Infrastructure modification method 200 dynamically generates, and then automatically submits, a first prompt to the LLM 145. The first prompt is configured to initiate generation of a modified LIT from the changed infrastructure requirements 135 and the existing LIT. After capturing the modified LIT from the response of the LLM 145 to the first prompt, infrastructure modification method 200 dynamically generates, and then automatically submits, a second prompt to the LLM 145. The second prompt is configured to initiate generation of a modified PIT from the changed infrastructure requirements 135 and the modified LIT that was generated by the LLM 145 in response to the first prompt. And, infrastructure modification method 200 captures the modified PIT from a response of the LLM to the prompt. Here, the modified graph is the modified PIT.

In one embodiment, automatic generation of the modified graph 140 from the existing graph 130 and the changed infrastructure requirements 135 using the LLM 145 (discussed at block 215) includes steps to produce, as modified graph 140, a modified LIT when the existing LIT does not satisfy the changed infrastructure requirements 135. As discussed in detail with reference to infrastructure modification process 300, in one embodiment the infrastructure modification method 200 determines that an existing LIT does not satisfy the changed infrastructure requirements 135. Infrastructure modification method 200 dynamically generates, and then automatically submits, a prompt to the LLM 145. The prompt is configured to initiate generation of a modified LIT from the changed infrastructure requirements 135 and the existing LIT. And, infrastructure modification method 200 captures the modified LIT from a response of the LLM 145 to the prompt. Here, the modified graph is the modified LIT.

In one embodiment, conversion of the modified graph 140 into an executable deployment specification 150 (discussed at block 220) includes steps to check whether the modified graph is a PIT graph that is directly convertible to an executable deployment specification 150, or a LIT graph that takes an intermediate translation into a PIT graph before conversion to an executable deployment specification 150. In one embodiment, the infrastructure modification method 200 determines that the modified graph is a logical infrastructure topology. This determination may be based on whether non-functional requirements (indicative of a PIT graph) are present in the modified graph 140, or not (therefore indicating a LIT graph). Then, the infrastructure modification method 200 translates the modified graph 140 into a PIT graph, which may in turn be converted to a deployment specification 150. In one embodiment, the translation of the modified graph 140 from LIT graph to PIT graph is performed by an additional LLM. The additional LLM has been trained to translate from LIT graph to PIT graph based on the changed infrastructure requirements and the LIT graph that the modified graph 140 has been determined to be.

In one embodiment, before proceeding to convert the modified graph 140 into the executable deployment specification 150 (discussed at block 220), infrastructure modification method 200 performs steps to allow user validation of the modified graph 140. Infrastructure modification method 200 presents the modified graph 140 for validation by a user in the user interface 125. Infrastructure modification method 200 accepts a user input associated with correction of the modified graph 140 through the user interface 125. Infrastructure modification method 200 initiates a fine-tuning—that is, cumulative training—of the LLM 145 based on the correction. The fine-tuning of LLM 145 includes training of the pre-trained LLM 145 on the domain-specific dataset of the corrections provided in the validation process in order to further adapt LLM 145 to that task of graph modification. And, infrastructure modification method 200 re-generates the modified graph 140 using the fine-tuned LLM 145.

In one embodiment, infrastructure modification method 200 includes training the LLM 145 with one or more triplets of training data. A triplet of the training data includes an example existing graph, example changed infrastructure requirements associated with the example existing graph, and an example modified graph that is modified from the example existing graph to conform to the changed infrastructure requirements. In one embodiment, the example modified graph is modified from the example existing graph to conform to the example changed infrastructure requirements in a manner that is deemed satisfactory for training the LLM 145. In one embodiment, the modifications to the example existing graph to change it into the example modified graph are made by humans.

In one embodiment, the existing graph 130 and the modified graph 140 are represented as collections of tokens in a graph representation language.

In one embodiment, the executable deployment specification 150 is written in YAML code or HCL code.

### —Example Infrastructure Modification Process—

In one embodiment, the infrastructure modification system produces changes to an existing infrastructure design. The changes are based on a set of training data that includes original infrastructure requirements, changed infrastructure requirements, and corresponding LIT or PIT graph changes. In one embodiment, the infrastructure modification system avoids producing a LIT or PIT that is totally different (i.e., the old and the new graphs have an empty intersection, in other words, no common elements exist between the old and new graphs) from an existing LIT or PIT (respectively). In other words, the infrastructure modification system minimizes the effect of the changes on the existing infrastructure design. Note that there may be changes resulting in a totally different LIT and/or PIT, even if LLM is trying to minimize the changes. This may occur, for example, where a technology change in compute resources has occurred in between generation of the old and the new LIT and/or PIT.

In one embodiment, where a change to an existing infrastructure design is introduced, it is initially introduced in the infrastructure requirements. A change to the infrastructure requirements may or may not result in a change to the LIT. A change to the infrastructure requirements may or may not result in a change to the PIT. A difference between an existing graph g₀ and a modified graph g₁ is a difference set containing nodes and edges of the modified graph g₁ that are absent in the existing graph g₀. Where the difference set is empty, changed graph g₁ and existing graph g₀ are equivalent (g₁=g₀).

In one embodiment, there are a plurality of inputs to the infrastructure modification process. The inputs include the original or existing infrastructure requirements Req₀, the existing LIT LIT₀ resulting from the original infrastructure requirements Req₀, and the existing PIT PIT₀ resulting from the original infrastructure requirements Req₀ and existing LIT LIT₀. The inputs include the new or changed infrastructure requirements Req₁. (Note that while the inputs to the infrastructure modification process do not include the modified LIT LIT₁ and modified PIT PIT₁, the modified LIT and modified PIT graphs may be referred to herein by these designations.) LIT₀ and PIT₀ have been verified to support or satisfy Req₀.

In one embodiment, the LLM used to generate modified LIT or PIT is not restricted to a single result. For example, the LLM used to generate the modified LIT or PIT is taught or trained to produce multiple valid results, provided each of the multiple results satisfies the infrastructure requirements. The number of results may be limited to a pre-specified quantity Nas part of LLM configuration (e.g., N=50). Thus, for a single set of infrastructure requirements, the LLM may produce up to 50 LIT, and for each of the 50 LIT, the LLM may produce up to 50 PIT, or 2500 PIT total. More generally, for a single set of infrastructure requirements, the LLM may produce up to N LIT, and N*N PIT. As a practical matter, the value of N can scale roughly with the complexity of the graph, with simpler topologies using fewer LIT and PIT options. In one embodiment, values of N between 40 and 60, e.g., 50 produce satisfactory numbers of options.

From the many possible infrastructure topologies generated by the LLM, a single LIT and a single PIT corresponding to the single LIT are selected as the modified graphs LIT₁ and PIT₁ resulting from the infrastructure modification process. As discussed above, the graphs may be selected based on applying one or more criteria. For example, the criteria for selection may be minimum topology difference—that is, the fewest differences in the graph or smallest difference set—between the existing graph g₀ and the modified graph g₁. In other words, the selection is done based on the minimum graph difference between the new infrastructure (represented by modified graph g₁) and the pre-existing infrastructure (represented by existing graph g₀).

As an initial check on whether the infrastructure needs to be modified in view of the changed infrastructure requirements, existing PIT PIT₀ is checked for satisfying changed infrastructure requirements Req₁. If changed infrastructure requirements Req₁ are satisfied, no further action is required: The current infrastructure already supports or satisfies the changed infrastructure requirements Req₁. (LIT₁=LIT₀, PIT₁=PIT₀). Otherwise, existing PIT PIT₀ needs one or more changes in order to satisfy the changed infrastructure requirements Req₁.

Before proceeding to change the existing PIT PIT₀ into a modified PIT PIT₁, the infrastructure modification system first checks to determine whether the current LIT LIT₀ (which lays out the underlying logical arrangement of the physical structure of the existing PIT PIT₀) also needs to be changed into a modified LIT LIT₁ to satisfy the changed requirements Req₁. Where the current LIT LIT₀ satisfies the changed requirements Req₁ and the existing PIT PIT₀ does not, LIT₁=LIT₀, PIT₁ #PIT₀, and the infrastructure modification system proceeds to generate the modified pit PIT₁ directly from the current LIT LIT₀=LIT₁. The infrastructure modification system generates the modified PIT PIT₁ using changed requirements Req₁ and the modified LIT LIT₁. If multiple valid PIT₁s are possible to be generated from the modified LIT LIT₁, the infrastructure modification system generates the multiple PIT₁s, up to a reasonable maximum (e.g., N, and then selects the one of the generated PIT₁s where the difference between the PIT₁ and the PIT₀ is minimal.

In the remaining case, where neither of the current LIT LIT₀ and the existing PIT PIT₀ satisfies the changed requirements Req₁, LIT₁≠LIT₀, PIT₁≠PIT₀, and the infrastructure modification system proceeds to generate a modified LIT LIT₁ from which it then generates the modified PIT PIT₁. In short, the LIT needs changes, and subsequently, the PIT needs changes, in order to satisfy the infrastructure requirements. The infrastructure modification system generates the modified LIT LIT₁ using changed requirements Req₁ and the current LIT LIT₀. If multiple valid LIT₁ results are possible, the infrastructure modification system generates multiple LIT₁s and selects the one where the difference between the current LIT LIT₀ and the modified LIT LIT₁ is minimal. The infrastructure modification system then uses the changed requirements Req₁ and the modified LIT LIT₁ as inputs to generate the one or more possible modified PIT PIT₁s. Then, the infrastructure modification system selects the one of the modified PIT₁s that is minimally different from the existing PIT PIT₀.

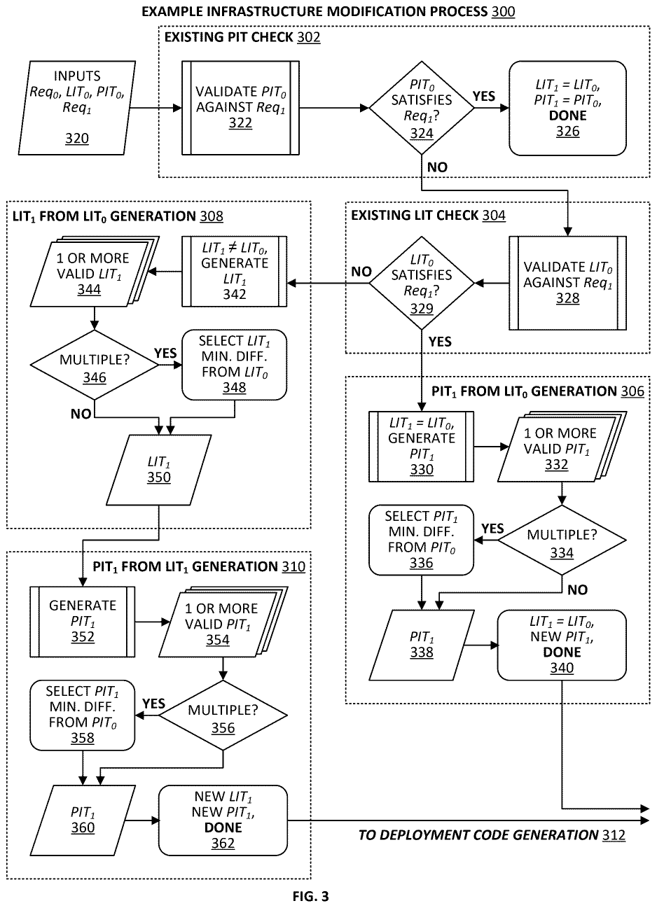

Additional detail regarding this process for modification of existing infrastructure designs is provided below with reference to FIG. 3.

Note that, in one embodiment, the selection of graphs is performed at each level, with one possible modified LIT selected at the LIT level or phase of the process, and then one possible modified PIT selected at the PIT level or phase of the process. This staged selection of graphs at the separate levels is performed rather than generating all of the possible modified LITs, and from the modified LITs, generating all of the possible modified PITs, and then selecting the pairing of modified LIT and PIT that most satisfies the criteria. This second method of selection may be less efficient than the first, staged selection of graphs at the separate levels.

In one embodiment, the minimal difference between graphs is determined based on nodes. If there is no difference in nodes, then as a fallback, the minimal difference between graphs may be determined based on edges. Note that other methods or criteria for selecting the modified graph may be applied. For example, a minimal projected elapsed time of enacting the change. For example, rather than minimal difference in graph nodes, a minimal cost of performing the change may be used as the criteria. For example, the infrastructure cost case. The infrastructure modification system may build and evaluate a cost case or cost function for changed infrastructure or the changed portion of the infrastructure and then infrastructure modification system will select the modified graph that results in the minimal cost. For example, one larger compute instance may be more expensive than multiple smaller compute instances that jointly provide the same computing power as the larger compute instance.

FIG. 3 illustrates an example infrastructure modification process 300 that is associated with modification of existing infrastructure designs by an LLM. At a high level, infrastructure modification process 300 performs steps for automatically adjusting an existing infrastructure graph to conform to changed human language infrastructure requirements, and automatically producing and executing a deployment specification to configure infrastructure that conforms to the changed infrastructure requirements. In one embodiment, infrastructure modification process 300 is one embodiment of the functions that graph modifier 110 of infrastructure modification system 100 is configured to perform, and one embodiment of the functions described with reference to block 212 of infrastructure modification method 200. In one embodiment, the infrastructure modification process may be broken down into a plurality of subprocesses or stages, including existing PIT check 302, current LIT check 304, PIT₁ from LIT₀ generation 306, LIT₁ from LIT₀ generation 308, and PIT₁ from LIT₁ generation 310 stages. The modified (new) graphs generated by infrastructure modification process 300 may be transferred to a deployment code generation 312 stage, for example as performed by specification generator 115 of infrastructure modification system 100, or as described with reference to block 220 of infrastructure modification method 200. As discussed above, inputs 320 to infrastructure modification process 300 include original infrastructure requirements Req₀, existing LIT LIT₀, existing PIT PIT₀, and changed infrastructure requirements Req₁.

In one embodiment, existing PIT check 302 is configured to check the PIT representing the original infrastructure, current or existing PIT PIT₀, to determine whether or not the existing PIT PIT₀ satisfies the changed infrastructure requirements Req₁. Existing PIT check 302 operates to validate PIT₀ against Req 322. Validate PIT₀ against Req₁ 322 compares the existing PIT PIT₀ and changed infrastructure requirements Req₁ to determine whether the existing PIT PIT₀ conforms to or deviates from the changed infrastructure requirements Req₁. In one embodiment, the validation is performed by LLM. In one embodiment, validate PIT₀ against Req₁ 322 first dynamically generates a prompt to an LLM configured to cause the LLM to analyze the compliance of PIT₀ with Req₁. For example, validate PIT₀ against Req₁ 322 may load and populate a template prompt, such as “The physical infrastructure topology is: [PIT0]. The infrastructure requirements are [Req1]. Please provide a yes or no response to the following question: does the physical infrastructure topology completely satisfy the infrastructure requirements?” Other template prompts may be used to refine the accuracy of the output. The placeholder [PIT0] is replaced with the GRL code for the graph of PIT₀. The placeholder [Req₁] is replaced with the text of the requirements of Req₁. Validate PIT₀ against Req₁ 322 submits the populated template prompt to the LLM, and captures the response from the LLM that answers the question.

At decision block 324, existing PIT check 302 evaluates the response from the LLM to determine whether or not existing PIT PIT₀ satisfies changed infrastructure requirements Req₁. Where the answer is yes, true, or other similar affirmative response (324:YES), example infrastructure modification process 300 proceeds to block 326 and terminates. The modified logical infrastructure topology LIT₁ is the same as the existing logical infrastructure topology LIT₀, and the modified physical infrastructure topology PIT₁ is the same as the existing physical infrastructure topology PIT₁ (LIT₁=LIT₀, PIT₁=PIT₀). Where existing PIT PIT₀ satisfies changed infrastructure requirements Req₁, the current or existing physical infrastructure already satisfies the infrastructure requirements, and no update to the physical infrastructure design will be performed. Where the answer is no, false, or other similar negative response (324:NO), the existing or existing PIT PIT₀ will need modification before it satisfies the changed requirements Req₁, and the existing or current LIT LIT₀ should be checked for compliance with the changed requirements Req₁ and so infrastructure modification process 300 moves on to current LIT check 304.

In one embodiment, current LIT check 304 is configured to check the LIT representing the original infrastructure, existing PIT PIT₀, to determine whether or not the current or existing LIT LIT₀ satisfies the changed infrastructure requirements Req₁. Current LIT check 304 operates to validate LIT₀ against Req 328. Validate LIT₀ against Req₁ 328 compares the existing LIT LIT₀ and changed infrastructure requirements Req₁ to determine whether the existing LIT LIT₀ conforms to or deviates from the changed infrastructure requirements Req₁. In one embodiment, the validation is performed by LLM. In one embodiment, validate LIT₀ against Req₁ 328 first dynamically generates a prompt configured to cause an LLM to analyze the compliance of LIT₀ with Req₁. For example, validate LIT₀ against Req₁ 328 may load and populate a template prompt, such as “The logical infrastructure topology is: [LIT0]. The infrastructure requirements are [Req1]. Please provide a yes or no response to the following question: does the logical infrastructure topology completely satisfy the infrastructure requirements?” Other template prompts may be used to refine the accuracy of the output. The placeholder [LIT0] is replaced with the GRL code for the graph of LIT₀. The placeholder [Req1] is replaced with the text of the infrastructure requirements of Req₁. Validate LIT₀ against Req₁ 328 submits the populated template prompt to the LLM, and captures the response from the LLM that answers the question.

At decision block 329, current LIT check 304 evaluates the response from the LLM to determine whether or not existing LIT LIT₀ satisfies changed infrastructure requirements Req₁. Where the answer is yes, true, or other similar response (329:YES), the existing LIT LIT₀ does not need modification to satisfy the changed infrastructure requirements Req₁ while the existing PIT PIT₀ does need modification (LIT₁=LIT₀, PIT₁≠PIT₀). And, so, example infrastructure modification process 300 proceeds to PIT₁ from LIT₀ generation 306. Where the answer is no, false, or other similar response (329:NO), both the existing LIT LIT₀ and the existing PIT PIT₀ need modification to satisfy the changed infrastructure requirements Req₁ (LIT₁≠LIT₀, PIT₁≠PIT₀). And, so, example infrastructure modification process 300 proceeds to LIT₁ from LIT₀ generation 308.

In one embodiment, PIT₁ from LIT₀ generation 306 is configured to generate a modified PIT PIT₁ based on the current or existing LIT LIT₀ and the changed requirements Req₁. Thus, using LIT₀ and Req₁ as input, generate PIT₁ 330 generates PIT₁. Generate PIT₁ 330 may produce 1 or more valid PIT₁ 332, one of which is selected to be output as the final, modified PIT₁ 338 (as discussed in further detail below). Once PIT₁ 338 is chosen, example infrastructure modification process 300 proceeds to block 340, and the modified PIT, PIT₁ 338 is made available for deployment code generation 312.

Decision block 334 determines whether multiple PITs that are distinct have been created. Graphs such PITs are distinct from another where one graph includes elements such as nodes and edges (and in the case of PITs, configuration details) that are not present in the other graph. Where multiple unique PITs may result from existing LIT LIT₀, generate PIT₁ 330 may produce a plurality of different variations of modified PIT PIT₁ (334:YES), up to a maximum number N. Select PIT₁ minimally different from PIT₀ 336 then chooses the one of the modified PITs which differs least from the existing PIT PIT₀ to be the output PIT₁ 338. In other words, PIT₁ from LIT₀ generation 306 chooses the one of the modified PITs where PIT₁-PIT₀ is minimal to be the output PIT₁ 338. (In one embodiment, PIT₁-PIT₀ is the minimum number of node elements in the difference set representing the difference of the two graphs PIT₁ and PIT₀.) Alternatively, PIT₁ from LIT₀ generation 306 chooses the one of the modified PITs which most satisfies some other criterion, such as having least total operating cost. Where there is only one unique PIT produced by generate PIT₁ 330 (334:NO), the single PIT is chosen to be the output PIT₁ 338.

In one embodiment, generate PIT₁ 330 is performed using an LLM. For example, generate PIT₁ 330 executes in a loop to cause an LLM to generate PIT₁ from LIT₀ and Req₁ N times, with a temperature hyperparameter set so as to cause the generated PIT₁ to vary from iteration to iteration of the loop. The loop creates N variations of PIT₁, where N is a pre-determined reasonable maximum number of PITs variations to be considered. In the loop, generate PIT₁ 330 first dynamically generates a prompt to the LLM configured to cause the LLM to generate a PIT₁ from LIT₀ and Req₁. Then, generate PIT₁ 330 submits the populated template prompt and the temperature parameter to the LLM, and captures the response of a PIT₁ from the LLM. The loop repeats until N total PIT₁ are created (e.g., one or more valid PIT₁ 332).

The temperature hyperparameter controls the diversity and randomness (or non-determinism) of the GRL code generated in response to the prompt. In a temperature scale that ranges from 0 upward, temperature values closer to zero cause generated code to be less diverse and random, and more deterministic, and temperature values approaching or exceeding one cause generated code generative to be highly diversified and random, and less deterministic, although at the risk of introducing semantically unusual or syntactically incorrect GRL code. As a practical matter, higher temperature values in the range greater than 0.8 have a tendency to introduce too many variations, which may lead to invalid graphs, while lower temperature values in the range of 0.0-0.2 introduce too few variations to produce substantial variety of generated graphs. Accordingly, in one embodiment, a temperature hyperparameter value between 0.2 and 0.8 may be satisfactory. For example, a temperature hyperparameter of 0.4 may be used. In one embodiment, the temperature hyperparameter may be dynamically incremented within a given range, such as between 0.2 and 0.8 over the course of several loop iterations until the LLM ceases to produce substantially identical graphs from one iteration of the loop to the next, and instead produces graphs that vary with respect to the previous interaction by at least a threshold amount.

As above, the template prompt includes populatable placeholder fields that the infrastructure modification system fills with relevant information. For example, generate PIT₁ 330 may load and populate a template prompt, such as “The logical infrastructure topology is: [LIT0]. The infrastructure requirements are: [Req1]. Physical infrastructure topologies are to be generated in: [GraphRepresentationLanguage]. Generate a physical infrastructure topology graph that conforms to the infrastructure requirements and the logical infrastructure topology.” The placeholder [LIT0] is replaced with the GRL code for the graph of LIT₀. The placeholder [Req1] is replaced with the text of the infrastructure requirements of Req₁. Other template prompts may be used to refine the accuracy of the output.

Where an existing LIT LIT₀ needs changes in order to conform to the changed infrastructure requirements Req₁ (329:NO), subsequently the existing PIT PIT₀ will also need changes in order to conform to the changed infrastructure requirements Req₁. Accordingly, infrastructure modification process 300 will perform LIT₁ from LIT₀ generation 308 followed by PIT₁ from LIT₁ generation 310. This is an alternative path to producing PIT₁ from that through PIT₁ from LIT₀ generation 306 that is followed when the existing LIT LIT₀ does not need changes in order to conform to the changed infrastructure requirements Req₁ (329:YES).

In one embodiment, LIT₁ from LIT₀ generation 308 is configured to generate a modified LIT LIT₁ based on the current or existing LIT LIT₀ and the changed requirements Req₁. Thus, using LIT₀ and Req₁ as input, generate LIT, 342 generates LIT₁. Generate LIT₁ 342 may produce 1 or more valid LIT₁ 344, one of which is selected to be output as the final, modified LIT₁ 350 (as discussed in further detail below). Once LIT₁ 350 is chosen, example infrastructure modification process 300 proceeds to PIT₁ from LIT₁ generation 310.

Decision block 346 determines whether multiple LIT₁s that are distinct have been created. Where multiple unique LIT₁s may result from existing LIT LIT₀, generate LIT₁ 342 may produce a plurality of different variations of modified LIT LIT₁ (346:YES), up to a maximum number N. In various embodiments, the value of N for LIT₁ from LIT₀ generation 308 may be the same as or different from the value of N for PIT₁ from LIT₀ generation 306. Select LIT₁ minimally different from LIT₀ 348 then chooses the one of the modified LITs LIT₁s which differs least from the current LIT LIT₀ to be the output LIT₁ 350. In other words, LIT₁ from LIT₀ generation 308 chooses the one of the modified LITs LIT₁s where LIT₁-LIT₀ is minimal to be the output LIT₁ 350. (In one embodiment, LIT₁-LIT₀ is the minimum number of node elements in the difference set representing the difference of the two graphs LIT₁ and LIT₀.) Alternatively, LIT₁ from LIT₀ generation 308 may choose the one of the modified LITs which most satisfies some other criterion. Where there is only one unique modified LIT LIT₁ produced by generate LIT₁ 342 (346:NO), the single modified LIT LIT₁ is chosen to be the output LIT₁ 350.

In one embodiment, generate LIT₁ 342 is performed using an LLM. For example, generate LIT₁ 342 executes in a loop to cause the LLM to generate LIT₁ from LIT₀ and Req₁ N times, with a temperature hyperparameter set so as to cause the generated LIT₁ to vary from one iteration of the loop to a next iteration (similar to the looping described above with reference to generate PIT₁ 330). The loop produces N variations of LIT₁, where N is a pre-determined reasonable maximum number of LIT variations to be considered. In the loop, generate LIT₁ 342 first dynamically generates a prompt to an LLM configured to cause the LLM to generate a LIT₁ from LIT₀ and Req₁. As above, generate LIT₁ 342 then submits the populated template prompt and the temperature hyperparameter to the LLM, and captures the response of a LIT₁ from the LLM. The loop repeats until N total LIT₁ are created (e.g., one or more valid LIT₁ 344).

As above, the template prompt includes populatable placeholder fields that the infrastructure modification system fills with relevant information. For example, generate LIT₁ 342 may load and populate a template prompt, such as “The current logical infrastructure topology is: [LIT0]. The infrastructure requirements are: [Req1]. Logical infrastructure topologies are to be generated in: [GraphRepresentationLanguage]. Generate a modified logical infrastructure topology graph that conforms to the infrastructure requirements and, where possible, conform to the current logical infrastructure topology.” The placeholder [LIT0] is replaced with the GRL code for the graph of LIT₀. The placeholder [Req1] is replaced with the text of the infrastructure requirements of Req₁. Other template prompts may be used to refine the accuracy of the output.

In one embodiment, PIT₁ from LIT₁ generation 310 is configured to generate a modified PIT PIT₁ based on the modified LIT LIT₁ and the changed requirements Req₁. Thus, using LIT₁ and Req₁ as input, generate PIT₁ 352 generates PIT₁. Generate PIT₁ 352 may produce 1 or more valid PIT₁ 354, one of which is selected to be output as the final, modified PIT₁ 360 (as discussed in further detail below). Once PIT₁ 360 is chosen, example infrastructure modification process 300 proceeds to block 362, where the modified PIT, PIT₁ 360 is made available for deployment code generation 312.

Decision block 356 determines whether multiple P/Tis that are distinct have been created. Where multiple unique PIT₁s may result from modified LIT LIT₁, generate PIT₁ 352 may produce a plurality of different variations of modified PIT PIT₁ (356:YES), up to a maximum number N. As noted above, the value of N for PIT₁ from LIT₁ generation 310 may be the same as or differ from the value of N for LIT₁ from LIT₀ generation 308 or LIT₀ generation 306. Select PIT₁ minimally different from PIT₀ 358 then chooses the one of the modified PITs PIT₁s which differs least from the existing PIT PIT₀ to be the output PIT₁ 360. In other words, PIT₁ from LIT₁ generation 310 chooses the one of the modified PITs PIT₁s where PIT₁-PIT₀ is minimal to be the output PIT₁ 360. As above, PIT₁ from LIT₁ generation 310 may also be configured to choose the one of the modified PITs which most satisfies some other criterion. Where there is only one unique modified PIT PIT₁ produced by generate PIT₁ 352 (356:NO), the single modified PIT PIT₁ is chosen to be the output LIT₁ 360.

In one embodiment, generate PIT₁ 352 is performed using an LLM. For example, generate PIT₁ 352 executes in a loop to cause an LLM to generate PIT₁ from LIT₁ and Req₁ N times, with a temperature hyperparameter set so as to cause the generated PIT₁ to vary from one iteration of the loop to a next iteration (similar to the looping described above with reference to generate PIT₁ 330 and generate LIT₁ 342). The loop results in the LLM generating N variations of PIT₁, where N is a pre-determined reasonable maximum number of PIT various to be considered. Note that the value of N may be the same, or may be different, for generate PIT₁ 330, generate LIT₁ 342, and generate PIT₁ 352. In the loop, generate PIT₁ 352 first dynamically generates a prompt to an LLM configured to cause the LLM to generate a PIT₁ from LIT₁ and Req₁. As above, generate PIT₁ 352 submits the populated template prompt and the temperature hyperparameter to the LLM, and captures the response of a PIT₁ from the LLM. The loop repeats until N total PIT₁ are created (e.g., one or more valid PIT₁ 354).

Again, the template prompt includes populatable placeholder fields that the infrastructure modification system fills with relevant information. For example, generate PIT₁ 352 may load and populate a template prompt, such as “The modified logical infrastructure topology is: [LIT1]. The infrastructure requirements are: [Req1]. Physical infrastructure topologies are to be generated in: [GraphRepresentationLanguage]. Generate a physical infrastructure topology graph that conforms to the infrastructure requirements and the modified logical infrastructure topology.” The placeholder [LIT1] is replaced with the GRL code for the graph of LIT₁. The placeholder [Req1] is replaced with the text of the infrastructure requirements of Req₁. Other template prompts may be used to refine the accuracy of the output.

Operations of deployment code generation stage 312 are described above with reference to process block 220. In one embodiment, the operations of deployment code generation stage 312 are performed by specification generator 115.

In one embodiment, dedicated LLMs are used for the various graph validation and graph modification tasks. The individual dedicated LLMs are specialized by their training for performing their particular tasks. The LLM for validate PIT₀ against Reg, 322 is trained to determine a binary condition: whether a PIT satisfies a particular set of infrastructure requirements, or not. The LLM for validate LIT₀ against Reg, 328 is trained to determine a binary condition: whether a LIT satisfies a particular set of infrastructure requirements, or not. The LLM for generate LIT₀ 342 is trained to generate a modified LIT that is valid and consistent with inputs of a set of infrastructure requirements and consistent with a current LIT except to the extent contradicted by the set of infrastructure requirements. In one embodiment, generate PIT₁ 330 and generate PIT₁ 352 share an LLM, which is trained to generate multiple PITs that are valid and consistent with inputs of a set of requirements and a logical infrastructure topology. In one embodiment, one general purpose LLM is used for the various graph validation and graph modification tasks, and has received the training for performing the various tasks discussed above. In one embodiment, the LLM(s) are LLM 145, which is specially configured to modify existing graphs to conform to changed infrastructure requirements 135. Further detail on training of LLMs is discussed below under the heading “Example LLM training”.

In one embodiment, the dynamically generated prompts for generation of modified LITs and PITs are transmitted to and received by LLM 145. For example, infrastructure modification process 300 makes an API call to the LLM 145, submitting the prompt to initiate generation of the modified graph. LLM 145 tokenizes and embeds the prompt. LLM 145 determines entities to include in the modified graph based on the relationships between the tokenized and embedded changed infrastructure requirements and graph. LLM 145 generates a response, and returns the response to the infrastructure modification process 300, for example through an API endpoint. Infrastructure modification process 300 captures and stores the modified graphs returned by LLM 145. In one embodiment, the infrastructure modification process 300 may present a modified graph in the user interface 125 for validation (for example as discussed in further detail below) before releasing the modified graph to subsequent processing.

Infrastructure modification process 300 operates to modify an existing graph 130 (such as LIT₀ or PIT₀) to conform to changed infrastructure requirements 135. Existing graph 130 and changed infrastructure requirements 135 are provided as inputs to graph modification LLM 145. LLM 145 analyzes existing graph 130 and changed infrastructure requirements 135 to determine which portions of the existing graph 130 satisfy the changed infrastructure requirements 135, and which portions of the existing graph 130 do not satisfy the changed infrastructure requirements 135. In other words, the graph modification LLM 145 detects where the existing graph is affected by the changed infrastructure requirements 135. The graph modification LLM 145 then generates a modified graph 140 (such as LIT₁ or PIT₁) that satisfies the changed infrastructure requirements 135 with low modification (for example, with a minimal extent of modification needed to cause the existing graph 130 to conform to the changed infrastructure requirements). For example, for those portions of the existing graph 130 which satisfy the changed infrastructure requirements 135, the LLM duplicates them in the modified graph. And, for those portions of the existing graph 130 which do not satisfy the changed infrastructure requirements 135, the LLM 145 replaces them with newly-generated portions of graph which, together with the remaining unchanged infrastructure, do satisfy the changed infrastructure requirements 135.

In one embodiment, the modified graph 140 is then subjected to a graph validation process. In one embodiment, the modified graph 140 is presented in a user interface 125 to allow a user to enter inputs that accept the modified graph 140 as-is (indicating that the modified graph 140 is valid), or that apply corrections to the modified graph 140 (indicating that the modified graph 140 is not valid, or that the modified graph is valid but can be improved). Where the modified graph 140 is not valid or valid but can be improved, the graph validation errors determined in the graph validation process are placed into a training dataset for the graph modification LLM 145. An LLM training process is then performed to update the graph modification LLM 145. The modified graph 140 is then re-generated by the graph modification LLM 145. This loop may be repeated until the modified graph is determined to be valid.

In one embodiment, in the user interface 125, various colors, highlighting, or other graphical differentiation or emphases may be applied to the visualization of the modified graph to aid in review. For example, maintained portions of the modified graph g₁ that remain unchanged from the existing graph g₀ may be shown in a first color, such as black. Newly-generated portions of the modified graph g₁ that are added to or differ from the existing graph g₀ may be shown in a second color, such as red. Removed portions of the existing graph g₀ that are no longer a part of modified graph g₁ may be shown in gray. In one embodiment, the maintained, newly-generated, and removed portions may be tagged as such, for example by the LLM 145 applying corresponding tags for these statuses to the GRL code of the elements included in these portions.

Where the modified graph 140 is valid and is a PIT graph, processing proceeds directly to deployment code generation 312. Where the modified graph 140 is valid and is a LIT graph, processing proceeds to a PIT generation stage (such as PIT₁ from LIT₁ generation) 310—where modified graph 140 is translated from a LIT graph to a PIT graph—before continuing to deployment code generation 312.

### —Example LLM Training—

In one embodiment, the LLM 145 undergoes a training process, for example modification LLM training 350. Modification LLM training 350 trains the LLM 145 to generate modified graphs 140 from changed infrastructure requirements 135 based on a training dataset of training materials, such as modification. In one embodiment, modification LLM training 350 is based on an accumulation of previously defined example infrastructure graphs that have been modified into example modified graphs in response to example changed infrastructure requirements. The example existing and modified infrastructure graphs may be formatted as collections of tokens in a GRL. The example changed infrastructure requirements may be formatted as natural language text.

The LLM 145 is trained to generate a modified LIT graph that is an alteration of an existing LIT graph to conform with changed infrastructure requirements. The LLM 145 is trained for LIT modification on triplets that include an example existing LIT graph, example changed infrastructure requirements, and example modified LIT graph that conforms to the changed infrastructure requirements. The LLM 145 is trained to generate a modified PIT graph that is an alteration of an existing PIT graph to conform with changed infrastructure requirements. The LLM 145 is trained for PIT modification on quadruplets that include an example existing PIT graph, example changed infrastructure requirements, example modified LIT graph that conforms to the changed infrastructure requirements, and example modified PIT graph that conforms to the changed infrastructure requirements.

The examples may be historical records of previous graph modification projects that were previously completed satisfactorily. For example, a cloud provider or cloud client may maintain a database of infrastructure solutions—including existing infrastructure graphs, changed infrastructure requirements for the infrastructure, and modified infrastructure graphs that are altered from the existing infrastructure graphs to conform to the changed infrastructure requirements—that are known to be correct, and which therefore provide a rich source of training data. The triplets of training examples may therefore be drawn from existing infrastructure deployments. The training of the LLM 145 is thus a reverse-engineering from existing deployments.

In one embodiment, the infrastructure modification system trains the LLM 145 on a broad dataset that includes a variety of existing graphs, changed infrastructure requirements, and resulting modified graphs. The training materials include one or more triplets of training data. A triplet of the training data includes an example existing graph, example changed infrastructure requirements associated with the example existing graph, and an example modified graph that is modified from the example existing graph to conform to the changed infrastructure requirements. In one embodiment, the example modified graph is modified from the example existing graph to conform to the example changed infrastructure requirements in a manner that is deemed satisfactory for training the LLM 145. In one embodiment, the modifications to the example existing graph to change it into the example modified graph are made by humans.

The training data may be manually curated, in which experts select triplets that are deemed to satisfy one or more thresholds for quality. The thresholds for quality may include: (1) the example modified graph being a correct representation of the example changed infrastructure requirements; and (2) the example modified graph being minimally changed from the example existing graph (e.g., within a threshold range of number of changes from a pre-determined minimum number of changes needed to conform to the changed infrastructure requirements). In one embodiment, the extent of changes may be measured as a percentage of the nodes and edges that are changed from the example existing graph to the example modified graph. Thus, a threshold for minimal change might be 5% or 10% beyond a minimum percentage determined to be possible by the experts curating the training data.

In one embodiment, infrastructure modification system 100 is configured to train LLM 145 by iteratively feeding triplets (for LIT modification) or quadruplets (for PIT modification) of a training batch into the LLM 145 to teach the LLM 145 mappings between existing graphs, changed infrastructure requirements, and modified graphs. Infrastructure modification system 100 accesses one or more batches of the training data, for example a quantity of triplets. Infrastructure modification system 100 updates weights of the LLM 145 to cause modified graphs generated from an example existing graph and corresponding example changed training requirements of a triplet to more closely match the corresponding example modified graph of the triplet. More generally, the parameters of the LLM are updated to reduce error or loss between the example modified graphs and the modified graphs produced from example existing graphs and example changed infrastructure requirements.

In one embodiment, separate, specialized LLMs are trained for modifying LIT graphs and for modifying PIT graphs. An LLM configured for modifying LIT graphs is trained on triplets of example existing LIT graphs, changed infrastructure requirements, and example modified LIT graphs. An LLM configured for modifying PIT graphs is trained on triplets of example existing PIT graphs, changed infrastructure requirements, and example modified PIT graphs.

In one embodiment, the LLM 145 may be trained or retrained through prompt engineering. Corrections may be provided to the LLM 145 through prompts containing human language statements. For example, the correction may be a human language statement of a rule, a human language statement modifying a rule, or a human language statement canceling a rule. In one embodiment, these prompts may be entered by a user through user interface 125, for example as part of validation of the graph. In one embodiment, the statement entered by the user may then be dynamically included or assembled into more formal prompt to the LLM 145, such as “In the modified graphs that you generate in the future, make sure to [statement].” The prompt may then be automatically injected into the LLM 145 through a chat endpoint, thereby adjusting the behavior of the LLM 145.

During the training process, parameters related to tokenization, size of the vector embeddings, and number of attention heads may be tuned or adjusted to improve results.

### —Cloud or Enterprise Embodiments—

In one embodiment, the present system (such as infrastructure modification system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, infrastructure modification system 100 is a centralized server-side application that provides at least the functions disclosed herein and that is accessed by many users by way of computing devices/terminals communicating with the computers of infrastructure modification system 100 (functioning as one or more servers) over a computer network. In one embodiment infrastructure modification system 100 may be implemented by a server or other computing device configured with hardware and software to implement the functions and features described herein.

In one embodiment, the components of infrastructure modification system 100 may be implemented as sets of one or more software modules executed by one or more computing devices specially configured for such execution. In one embodiment, the components of infrastructure modification system 100 are implemented on one or more hardware computing devices or hosts interconnected by a data network. For example, the components of infrastructure modification system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of infrastructure modification system 100 intercommunicate by electronic messages or signals. These electronic messages or signals may be configured as calls to functions or procedures that access the features or data of the component, such as for example API calls. In one embodiment, these electronic messages or signals are sent between hosts in a format compatible with transmission control protocol/internet protocol (TCP/IP) or other computer networking protocol. Components of infrastructure modification system 100 may (i) generate or compose an electronic message or signal to issue a command or request to another component, (ii) transmit the message or signal to other components of infrastructure modification system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by infrastructure modification system 100, for example through a web interface server. In one embodiment, the remote computing system may send requests to and receive responses from infrastructure modification system 100. In one example, access to the information or applications may be effected through use of a web browser on a personal computer or mobile device. In one example, communications exchanged with infrastructure modification system 100 may take the form of remote REpresentational State Transfer (REST) requests using JavaScript Object Notation (JSON) as the data interchange format for example, or Simple Object Access Protocol (SOAP) requests to and from Extensible Markup Language (XML) servers. The REST or SOAP requests may include API calls to components of infrastructure modification system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

### —Computing Device Embodiment—

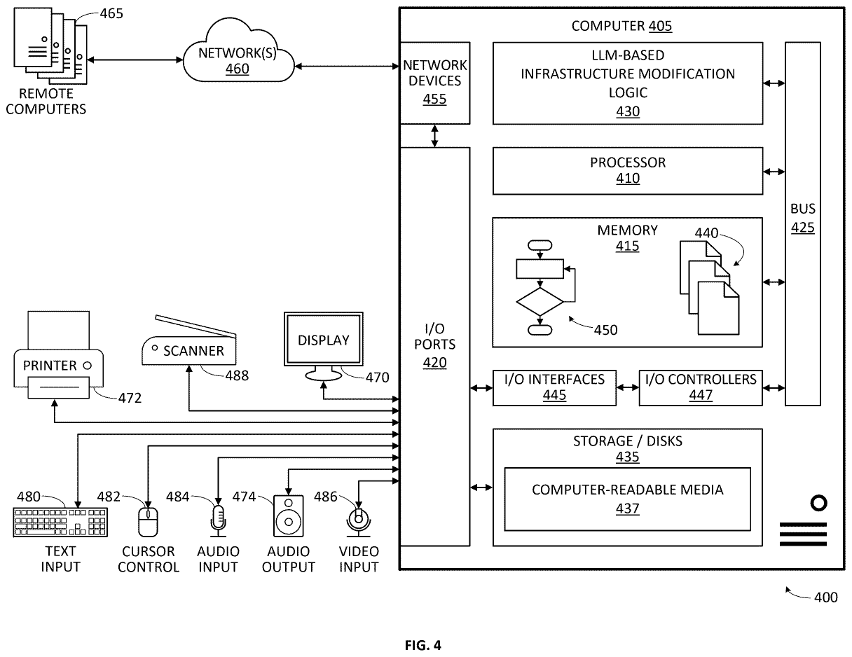

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include LLM-based infrastructure modification logic 430 configured to facilitate automated modification of existing infrastructure designs by an LLM, like the logic, systems, methods, and other embodiments shown in and described with reference to FIGS. 1,2, and 3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate automated modification of existing infrastructure designs by an LLM. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, fewer than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure,” as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium,” as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection,” or a connection by which entities are “operably connected,” is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User,” as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner like the term “comprising” as that term is interpreted when employed as a transitional word in a claim.

To the extent that the term “or” is used in the detailed description or claims (e.g., A or B) it is intended to mean “A or B or both.” When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
access an existing graph of compute infrastructure, wherein the existing graph represents a design of the compute infrastructure;
access changed infrastructure requirements for the compute infrastructure that differ from a design represented by the existing graph, wherein the changed infrastructure requirements are in human language;
automatically generate a modified graph from the existing graph and the changed infrastructure requirements using a large language model, wherein the large language model has been trained to re-generate portions of the existing graph where the compute infrastructure is unaffected by the changed infrastructure requirements and generate new graph portions where the compute infrastructure is affected by the changed infrastructure requirements;
convert the modified graph into a deployment specification; and
execute the deployment specification to automatically configure a target computer system to have modified compute infrastructure that conforms to the changed infrastructure requirements.

2. The one or more non-transitory computer-readable media of claim 1, wherein the instructions to automatically generate the modified graph from the existing graph and the changed infrastructure requirements using the large language model, when executed by at least the processor cause the computing system to:
dynamically generate a prompt to the large language model that is configured to initiate the generation of the modified graph from the changed infrastructure requirements and the existing graph; and
automatically submit the prompt to the large language model.

3. The one or more non-transitory computer-readable media of claim 1, wherein the instructions to automatically generate the modified graph from the existing graph and the changed infrastructure requirements, when executed by at least the processor, cause the computing system to:
determine that the existing graph is an existing physical infrastructure topology that does not satisfy the changed infrastructure requirements;
determine that an existing logical infrastructure topology that corresponds to the existing physical infrastructure topology does satisfy the changed infrastructure requirements;
dynamically generate a prompt to the large language model that is configured to initiate generation of a modified physical infrastructure topology from the changed infrastructure requirements and the existing logical infrastructure topology;
automatically submit the prompt to the large language model; and
capture the modified physical infrastructure topology from a response of the large language model to the prompt, wherein the modified graph is the modified physical infrastructure topology.

4. The one or more non-transitory computer-readable media of claim 1, wherein the instructions to automatically generate the modified graph from the existing graph and the changed infrastructure requirements, when executed by at least the processor, cause the computing system to:
determine that the existing graph is an existing physical infrastructure topology that does not satisfy the changed infrastructure requirements;
determine that an existing logical infrastructure topology that corresponds to the existing physical infrastructure topology does not satisfy the changed infrastructure requirements;
automatically submit a first prompt to the large language model that is configured to initiate generation of a modified logical infrastructure topology from the changed infrastructure requirements and the existing logical infrastructure topology;
automatically submit a second prompt to the large language model that is configured to initiate generation of a modified physical infrastructure topology from the changed infrastructure requirements and the modified logical infrastructure topology generated by the large language model in response to the first prompt; and
capture the modified physical infrastructure topology from a response of the large language model to the second prompt, wherein the modified graph is the modified physical infrastructure topology.

5. The one or more non-transitory computer-readable media of claim 1, further comprising instructions that when executed by at least the processor cause the processor to, before proceeding to convert the modified graph into the executable deployment specification:
present the modified graph for validation by a user;
accept a user input associated with correction of the modified graph;
initiate a fine-tuning of the large language model based on the correction; and
re-generate the modified graph using the fine-tuned large language model.

6. The one or more non-transitory computer-readable media of claim 1, wherein the existing graph and the modified graph are represented as collections of tokens in a graph representation language.

7. The one or more non-transitory computer-readable media of claim 1, wherein the executable deployment specification is written in YAML code or HCL code.

8. A computer-implemented method, comprising:
accessing an existing graph of compute infrastructure, wherein the existing graph represents a design of the compute infrastructure;
accessing changed infrastructure requirements for the compute infrastructure that differ from the design, wherein the changed infrastructure requirements are in human language;
automatically generating a modified graph from the existing graph and the changed infrastructure requirements using a large language model, wherein the large language model has been trained to re-generate portions of the existing graph where the compute infrastructure is unaffected by the changed infrastructure requirements and generate new graph portions where the compute infrastructure is affected by the changed infrastructure requirements;
converting the modified graph into a deployment specification; and
executing the deployment specification to automatically configure a target computer system to have modified compute infrastructure that conforms to the changed infrastructure requirements.

9. The computer-implemented method of claim 8, wherein automatically generating the modified graph from the existing graph and the changed infrastructure requirements using the large language model further comprises:
dynamically generating a prompt to the large language model that is configured to initiate the generation of the modified graph from the changed infrastructure requirements and the existing graph; and
automatically submitting the prompt to the large language model.

10. The computer-implemented method of claim 8, wherein automatically generating the modified graph from the existing graph and the changed infrastructure requirements using the large language model further comprises:
determine that an existing logical infrastructure topology does not satisfy the changed infrastructure requirements;
automatically submit a prompt to the large language model that is configured to initiate generation of a modified logical infrastructure topology from the changed infrastructure requirements and the existing logical infrastructure topology; and
capture the modified logical infrastructure topology from a response of the large language model to the prompt, wherein the modified graph is the modified logical infrastructure topology.

11. The computer-implemented method of claim 8, further comprising, before proceeding to convert the modified graph into the executable deployment specification:
presenting the modified graph for validation by a user;
accepting a user input associated with correction of the modified graph;
fine-tuning the large language model based on the correction; and
re-generating the modified graph using the fine-tuned large language model.

12. The computer-implemented method of claim 8, further comprising training the large language model with one or more triplets of training data, wherein a triplet of the training data includes an example existing graph, example changed infrastructure requirements associated with the example existing graph, and an example modified graph that is modified from the example existing graph to conform to the example changed infrastructure requirements in a manner that is deemed satisfactory for training the large language model.

13. The computer-implemented method of claim 8, wherein the existing graph and the modified graph are represented as collections of tokens in a graph representation language.

14. The computer-implemented method of claim 8, wherein the executable deployment specification is written in YAML code or HCL code.

15. A computing system, comprising:
a processor;
a memory;
one or more non-transitory computer-readable media that include stored thereon computer-executable instructions that, when executed by at least the processor, cause the computing system to:
access an existing graph of compute infrastructure, wherein the existing graph represents a design of the compute infrastructure;
access changed infrastructure requirements for the compute infrastructure that differ from the design, wherein the changed infrastructure requirements are in human language;
automatically generate a modified graph from the existing graph and the changed infrastructure requirements using a large language model;
convert the modified graph into a deployment specification; and
execute the deployment specification to automatically configure a target computer system to have modified compute infrastructure that conforms to the changed infrastructure requirements.

16. The computing system of claim 15, wherein the instructions to automatically generate the modified graph from the existing graph and the changed infrastructure requirements using the large language model, when executed by at least the processor cause the computing system to:
dynamically generate a prompt to the large language model that is configured to initiate the generation of the modified graph from the changed infrastructure requirements and the existing graph; and
submit the prompt to the large language model.

17. The computing system of claim 15, wherein the instructions to convert the modified graph into an executable deployment specification, when executed by at least the processor, cause the computing system to:
determine that the modified graph is a logical infrastructure topology; and
translate the modified graph into a physical infrastructure topology.

18. The computing system of claim 15, wherein the instructions, when executed by at least the processor, cause the computing system to, before proceeding to convert the modified graph into the executable deployment specification:
display the modified graph for validation by a user;
accept a user input associated with correction of the modified graph;
initiate a fine-tuning of the large language model based on the correction; and
re-generate the modified graph using the fine-tuned large language model.

19. The computing system of claim 15, wherein the instructions, when executed by at least the processor, cause the computing system to train the large language model with one or more triplets of training data, wherein a triplet of the training data includes an example existing graph, example changed infrastructure requirements associated with the example existing graph, and an example modified graph that is modified from the example existing graph to conform to the example changed infrastructure requirements.

20. The computing system of claim 15, wherein the existing graph and the modified graph are represented as collections of tokens in a graph representation language.
